(19) United States
(12) Patent Application Publication
(10) Pub. No.: US 2026/0244355 A1
(43) Pub. Date: Aug. 20, 2026

(54) Quality of Service of Memory Allocated from a Memory Space of a Memory Sub-System to Access a Storage Space of the Memory Sub-System

(71) Applicant: Micron Technology, Inc., Boise, ID (US)

(72) Inventor: Luca Bert, Bologna (BO) (IT)

(21) Appl. No.: 19/058,554

(22) Filed: Feb. 20, 2025

(51) Int. Cl. G06F 3/06

(52) U.S. Cl. CPC G06F 3/0631; G06F 3/0604; G06F 3/0679

(57) ABSTRACT

A memory sub-system having: memory cells of a first type to provide a first portion of a memory space; memory cells of a second type to provide a second portion of the memory space; and memory cells of a third type to provide a storage space. A controller of the memory sub-system is configured to: receive a request identifying at least one memory attribute specified by a host system; allocate, in view of the at least one memory attribute, a memory block from the memory space; and provide the host system with a response to the request to identify a memory address of the memory block.

### TECHNICAL FIELD

At least some embodiments disclosed herein relate to memory systems in general, and more particularly, but not limited to memory sub-systems configured to provide both memory and storage.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a memory sub-system having a storage space and a memory space that are both accessible to a host system according to one embodiment.

FIG. 3 shows a technique of using a storage access request to transfer data between a storage space and a memory space of a memory sub-system according to one embodiment.

FIG. 4 shows a technique of using a memory access request for data transferred between a storage space and a memory space of a memory sub-system according to one embodiment.

FIG. 5 to FIG. 7 show techniques to cause a memory sub-system to transfer data between a storage space of the memory sub-system and a memory space of the memory sub-system according to some embodiments.

FIG. 8 shows error correction encoding and decoding for data transfers between a storage space and a memory space of the memory sub-system according to one embodiment.

FIG. 9 to FIG. 13 show configurations of a memory sub-system having one or more connections to a host system for storage access and memory access according to some embodiments.

FIG. 14 shows communications to load a portion of data stored at a logical block address in a memory sub-system to a host system according to one embodiment.

FIG. 15 shows communications to store data from a host system to a logical block address in a memory sub-system according to one embodiment.

FIG. 16 and FIG. 17 show management of memory in a memory space of a memory sub-system according to one embodiment.

FIG. 18 shows integrating memory allocation requests in storage access requests according to some embodiments.

FIG. 19 shows examples of opcodes that can be used in a storage access request according to one embodiment.

FIG. 20 shows a memory sub-system having a memory space with different types of memory that can be allocated to a host system to access a storage space of the memory sub-system according to one embodiment.

FIG. 21 to FIG. 22 show examples of memory allocation requests having quality of service requests according to one embodiment.

FIG. 23 to FIG. 24 show examples of storage access requests having built-in memory requests with memory attributes for requested memory blocks according to one embodiment.

FIG. 25 shows examples of memory attributes usable in requests from a host system to cause a memory sub-system to allocate memory blocks according to one embodiment.

FIG. 26 shows a method to allocate a block of memory from a memory space in a memory sub-system configured with a storage space accessible via a storage access protocol according to one embodiment.

FIG. 27 is a block diagram of an example computer system in which embodiments of the present disclosure can operate.

### DETAILED DESCRIPTION

At least some aspects of the present disclosure are directed to techniques to facilitate efficient access of a storage space of a memory sub-system at a granularity level smaller than the level of an atomic read or write operation in the memory sub-system in retrieving data from memory cells or programming data into the memory cells.

A memory sub-system, such as a solid-state drive, can be configured to read or write data in a storage space according to a logical block addressing (LBA) block size. For example, to execute a read command, a solid-state drive retrieves at least one LBA block of data from a page of memory cells via an atomic read operation, in which the solid-state drive senses the states of the memory cells to determine the data stored in the memory cells and, decodes raw data corresponding to the states using an error correction code technique to recover the data stored in the page. To execute a write command, the solid-state drive encodes the data, having the LBA block size and to be programmed into the memory cells of the page, to generate encoded data, and programs the memory cells in the page in an atomic write operation, in which the solid state drive programs the states of the memory cells to represent the encoded data to represent the data being written into the page. The LBA block size is typically 512 bytes or larger (e.g., 4096 bytes) for improved efficiency of the solid-state drive in executing read and write commands.

However, some applications typically use a small chunk of data stored in an LBA block in a typical computation task. For example, a chunk of 128 bytes of data is typically used at a time for inference computations of an artificial neural network (ANN). It is inefficient to move an entire block of data, according to the LBA block size of 512 bytes or more (e.g., 4096 bytes), from the solid-state drive into the main memory of a processor only for the processor to use a chunk/sub block of 128 bytes of the entire block.

At least some aspects of the present disclosure address the above and other deficiencies and challenges by configuring a memory sub-system to expose at least a portion of its random access memory for access by a host system. The memory space of the exposed random access memory is configured to be separate and independent from the storage space of the memory sub-system. The host system can use storage access commands to instruct the memory sub-system to transfer data, according to the LBA block size and within the memory sub-system, between the random access memory of the memory sub-system and the storage space of the memory sub-system. Separately, the host system can use memory access instructions to load data from and/or store data to the exposed memory space of the memory sub-system at a granularity level that is smaller than the LBA block size. Thus, the host system can have the options to use a combination of memory access request and storage access request to retrieve data from and/or store data to the storage space of the memory sub-system by communicating sub blocks of data between the host system and the memory sub-system.

For example, the random access memory of the memory sub-system can be attached to the host system during a boot time as a memory device such that the host system can load data from and store data to the random access memory using a memory access protocol (e.g., a protocol of compute express link (CXL) or component interconnect express (PCIe)) and/or via executions of load instructions and store instructions. Further, the host system can send a read command to the memory sub-system to read a block of data according to the LBA block size of the memory sub-system into the random access memory of the memory sub-system using a storage access protocol (e.g., non-volatile memory express (NVMe)). During the execution of the read command, the data of the LBA block size is internally retrieved from the storage space of the memory sub-system and copied to the random access memory of the memory sub-system. As a result of the execution of the read command in the memory sub-system, the memory sub-system makes sub blocks of the data accessible to the host system in the random access memory of the memory sub-system without sending the data across the connection between the memory sub-system and the host system.

Once the data is in the random access memory of the memory sub-system, the host system has choices as to when and whether to load any portions of the data from the random access memory of the memory sub-system to the host system for processing. For example, the host system can use the memory access protocol (e.g., in accordance with CXL or PCIe) to load a selected portion of the data from the random access memory by addressing the selected portion using one or more memory addresses in the random access memory of the memory sub-system. Since the memory access protocol (e.g., CXL protocol) allows accessing the random access memory of the memory sub-system at the granularity level of byte (e.g., one byte, 8 bytes, 16 bytes, 32 bytes, or a cache line of 128 bytes), the host system can load a portion (e.g., sub block) of the block from the random access memory of the memory sub-system when the portion is about to be used in computation. Thus, the host system does not have to allocate a space in its main memory sufficient to hold the entire block of data according to the LBA block size; and the efficiency of the usage of the main memory of the host system is improved. In some cases, at least a portion of the entire block of data is not used in computations performed in the host system in a period of time. Thus, the host system can skip loading such a portion over a connection between the memory sub-system and the host system; and the efficiency of the usage of the communications bandwidth of the connection is improved.

For example, when the host system is to modify a portion of the data stored as a block according to the LBA block size in the storage space of the memory sub-system, the host system can use a read command to retrieve the block of data into the random access memory of the memory sub-system. Then, the host system can use the memory access protocol (e.g., CXL or PCIe) to store the modified portion of the block into the random access memory, without communications of the remaining portion of the block between the host system and memory sub-system. Subsequently, the host system can use a write command to cause the memory sub-system to write the block of data from the random access memory of the memory sub-system into the storage space of the memory sub-system. Thus, the efficiency of the usages of the main memory of the host system and the communications bandwidth of the connection between the memory sub-system and the host system can be improved.

For example, consider a scenario of using such a memory sub-artificial intelligence (AI) inference computations. A trained artificial neural network (ANN) model can be used to make inference/predictions. Inference/prediction computations can have many tasks running in parallel on different graphical processing unit (GPU) cores. There can be over a hundred GPUs in a cluster, where each GPU can have hundreds or more of cores. Potentially, there can be over 10,000 or so inference processes running in parallel, each running in a separate GPU core to access a different part of the memory sub-system (e.g., solid-state drive (SSD)) storing the AI/ANN model. Each part being accessed can be smaller than the LBA block size. The memory sub-system can be configured to support a large number of parallel commands coming from the inference processes running in the GPU cores. After an LBA block is read from an LBA address to the random access memory of the memory sub-system, an inference/prediction process/thread running in a GPU core can load the small portion that is to be used in its computation into the high bandwidth memory (HBM) of the GPU core, eliminating the need to allocate a sufficient space in the HBM to store the entire LBA block and eliminating the transfer of unused portions of the LBA block from the memory sub-system to the HBM of the GPU core. Instead of allocating memory from HBM at the granularity of an LBA block size (e.g., 4 KB) to hold data read from the memory sub-system, the inference/prediction process/thread can allocate memory from HBM at the granularity level of a cache line (e.g., 128 bytes). HBM is an expensive, high-performance resource in GPUs. Optionally, the inference/prediction process/thread can modify, in the HBM, the portion of the LBA block that has been loaded into the HBM of the GPU core; and to store the modified LBA block back to the storage space of the memory sub-system, the inference/prediction process/thread can identify the portion of the block in the HBM via a scatter gather list (SGL) to cause the memory sub-system to combine the portion in the HBM and the unmodified portion in the random access memory of the memory sub-system to write the modified LBA block to the storage space. Avoid loading unused portions of data into HBM can improve and optimize the usages of HBM as a key resource; and the performance of the system can be greatly improved.

Such a memory sub-system can have backward compatibility with storage access protocols (e.g., NVMe protocol). When the host system is to use an entire block of data according to the LBA block size, the host system can configure and send a read command to cause the memory sub-system to send the data retrieved from the storage space of the memory sub-system to a memory location identified by the host system. For example, the read command can be configured by the host system to identify a location in the main memory of the host system as the destination of the storage access request; and in response, the memory sub-system can send the retrieved data to the main memory of the host system during the execution of the read command such that it is not necessary for the host system to further use memory access protocols to load data from the memory sub-system.

Optionally, the host system can use the random access memory of the memory sub-system as a buffer to hold data retrieved from the storage space of the memory sub-system for a period of time decided by the host system. During the period of time, the host system can load any portion of the data from the random access memory and/or modify any portion of the data in the random access memory of the memory sub-system. Accessing the random access memory of the memory sub-system using a memory access protocol (e.g., CXL protocol) is much faster than accessing the storage space of the memory sub-system using a storage access protocol (e.g., NVMe protocol). Thus, such a memory sub-system provides the host system with the option to predicatively send read commands to the memory sub-system to retrieve data from the storage space for buffering in the random access memory of the memory sub-system to reduce latency in accessing the data for the processing of the data.

Optionally, the memory sub-system can be configured to provide a host system with access to both a memory space of the random access memory of the memory sub-system and the storage space of non-volatile memory cells of the memory sub-system via a same connection. The memory space and the storage space are separately addressable by the host system using a memory access protocol and a storage access protocol over the same connection.

For example, the memory sub-system can be configured with a random access memory addressable by a host system via a memory access protocol (e.g., compute express link (CXL) over a peripheral component interconnect express (PCIe) connection). The random access memory can be implemented using a fast memory that can be volatile (e.g., dynamic random access memory (DRAM)). The memory sub-system can offer the random access memory as a memory device attachable to the host system during the boot time; and the host system can be configured to add the memory space of the memory device offered by the memory sub-system into its memory map. Thus, the host system can access the random access memory of the memory sub-system in a same way as accessing other memory devices attached to the host system using the memory access protocol (e.g., CXL).

The memory sub-system can be further configured with a storage medium (e.g., NAND memory) addressable by a host system via a storage access protocol (e.g., non-volatile memory express (NVMe) over the peripheral component interconnect express (PCIe) connection). The storage medium is non-volatile and slower than the random access memory.

The memory sub-system allows a host system to access the memory space and the storage space independently without imposing a predefined relation between the memory space and the storage space. The memory space can be substantially smaller than the storage space. The memory sub-system can provide the host system with complete control over how the memory space is used by the host system. Optionally, the host system can use the memory space in accessing the storage space (e.g., to reduce communications over a computer bus between the memory sub-system and the host system).

For example, the memory sub-system can receive storage access commands configured to address the storage medium of the memory sub-system. The commands can be provided to the memory sub-system via submission queues configured in cyclic buffers accessible to both the host system and the memory sub-system. For example, the cyclic buffers can be configured in a portion of the main memory of the host system, or in the random access memory of the memory sub-system.

The storage medium of the memory sub-system is configured to be addressed at the granularity level of the LBA block size that is coarser than the granularity level of addressing the random access memory of the memory sub-system. For example, the storage medium can be accessed at a block level of 4096 bytes or 512 bytes per block. The random access memory can be access at a byte level (e.g., one byte, 16 bytes) or a cache line level (e.g., 128 bytes).

A storage access command (e.g., a read command or a write command) can be configured to identify a memory address for storing or retrieving data addressed by the storage access command. For example, a read command can specify a memory address as the destination to store the data to be read from the storage medium at a logical block addressing (LBA) address specified by the read command. For example, a write command can identify a memory address as the source where data can be retrieved for writing to the storage medium at a logical block addressing (LBA) address specified by the write command.

When the memory sub-system is configured to expose at least a portion of its random access memory for accessing by the host system, the host system can optionally configure the memory address, identified in the storage access command, in the random access memory of the memory sub-system. When the storage access command specifies a memory address that is in the random access memory of the memory sub-system, the execution of the storage access command does not involve communicating data over the connection between the host system and the memory sub-system.

The host system can use the random access memory of the memory sub-system as a staging ground for the data to be read from or written into the storage space of the memory sub-system. For example, the host system can assemble a block of data in the random access memory for writing into the storage medium of the memory sub-system, or prefetch a block of data from the storage medium into the random access memory for selective accessing a portion (e.g., a sub block) of the block. The availability of the staging ground within the memory sub-system can be used to reduce data traffic in the communication connection (e.g., the PCIe connection) between the memory sub-system and the host system in some applications, such as applications involving the computations of an artificial neural network.

The host system can be configured to access sub blocks of an LBA block in the storage space of the memory sub-system using a combination of storage access commands and memory access instructions. For example, the host system can be configured to allocate a block of random access memory from the memory sub-system and store data one chunk at a time into the allocated block of random access memory. When the block of data is ready in the random access memory for being stored into the storage space of the memory sub-system, the host system can enter a write command in a submission queue for the memory sub-system, where the write command is configured to cause the memory sub-system to write the data from the random access memory to the storage space of the memory sub-system.

Optionally, the host system can configure a storage access command (e.g., a read command or a write command) to specify a block of memory addresses having a capacity size that is different (e.g., smaller than) from the LBA block size. The memory sub-system can be configured to determine the size mismatch between the block of memory address identified by the storage access command and the data block being addressed via an LBA address specified in the storage access command. In response to a detected size mismatch, the memory sub-system can perform filtering operations and/or read operations accordingly.

For example, when the capacity size of the block of memory addresses identified in the storage access command is smaller than the LBA size and the storage access command includes an opcode for a write operation, the memory sub-system can perform a read-modify-write operation at the LBA address identified in the storage access command. For example, the memory sub-system can perform a read operation to retrieve the data block currently stored at the LBA address, modify the retrieved data block using the data currently at the block of memory addresses, and write the modified data block to the LBA address. Alternatively, the memory sub-system can use the data currently at the block of memory addresses to modify a block of data having a predetermined value (e.g., zero) to generate the modified data block for writing to the LBA address.

For example, when the capacity size of the block of memory addresses identified in the storage access command is smaller than the LBA size and the storage access command includes an opcode for a read operation, the memory sub-system can perform a filtering operation on the data read from the LBA address identified in the storage access command to generate the data being stored into the block of memory addresses. For example, the memory sub-system can remove the beginning portion and/or the ending portion of the data block read from the LBA address to generate the data having a size matching the capacity size of the block of memory addresses; the memory sub-system can store the generated data into the block of memory addresses to complete the execution of the storage access command.

Optionally, when the host system is to write only a portion of an LBA block into the storage space of the memory sub-system, the host system can allocate a block of the random access memory of the memory sub-system according to the LBA block size and send a read command to retrieve the data of the LBA block from the storage space into the allocated block of random access memory of the memory sub-system. Optionally, the read command can also function as a request to allocate the block of the random access memory of the memory sub-system. The host system can then store data to the portion of the block via memory access operations to modify the data of the LBA block in the random access memory. Subsequently, the host system can send a write command to cause the memory sub-system to write the modified block of data from the random access memory of the memory sub-system to the storage space of the memory sub-system. Optionally, the write command can function as a request to free the block of the random access memory allocated as the staging ground for the modified block of data.

To retrieve a sub block from the storage space of the memory sub-system, the host system can configure a read command to cause the memory sub-system to read a block (e.g., 4096 bytes or 512 bytes) of data into a block of the random access memory of the memory sub-system as a staging ground. Subsequently, the host system can execute one or more load instructions to fetch one or more portions of the block from the staging ground into its memory, such as a high bandwidth memory (HBM) in a graphics processing unit (GPU).

To write a block of data having the LBA block size to the storage space of the memory sub-system, the host system can execute store instructions to build up the block of data, one sub block a time, in the random access memory in the memory sub-system as a staging ground. After the completion of building the block of data, the host system can configure a write command to cause the memory sub-system to write the block of data from the staging ground in the memory sub-system into the storage space of the memory sub-system.

To write a sub block to the storage space of the memory sub-system, the host system can configure a read command to cause the memory sub-system to read a block (e.g., 4096 bytes or 512 bytes) of data, according to the LBA block size, into the random access memory of the memory sub-system as a staging ground. Then, the host system can execute one or more store instructions to modify one or more portions of the block in the staging ground. Then, the host system can configure a write command to cause the memory sub-system to write the modified block into the storage space of the memory sub-system.

Optionally, the memory sub-system can be configured to have multiple, separate connections to the host system such that the host system and the memory sub-system can use the connections in parallel for concurrent storage access communications and memory access communications.

For example, a first interface of the memory sub-system can provide a first connection between a host system and the memory sub-system to allow the host system to access the memory space of the memory sub-system; and a second interface of the memory sub-system can provide a second connection between the host system and the memory sub-system to allow the memory sub-system to access a memory of the host system. For example, while the first connection is being used by the host system to retrieve or modify a sub block of data in the memory space of the memory sub-system, the second connection can be used concurrently by the memory sub-system to retrieve a command from a submission queue configured in the memory of the host system, or write a completion record in a completion queue configured in the memory of the host system, or to retrieve data from (or store data to) the memory of the host system during execution of a write (or read) command that specifies a memory address in the memory of the host system as the data source (or destination).

Optionally, a random access memory external to the memory sub-system and the host processor can be used as the staging ground. For example, the memory sub-system can be configured with a first interface to access a random access memory outside of the memory sub-system. The random access memory can be provided by a memory device having random access memory cells and connected to the first interface of the memory sub-system (e.g., via a CXL connection and/or a CXL fabric). The memory sub-system can access the random access memory via a memory access protocol (e.g., compute express link (CXL)). The host processor can be configured to access the random access memory of the memory device (e.g., via another CXL connection and/or the CXL fabric) without going through any interface of the memory sub-system. The memory sub-system is configured with a storage medium (e.g., NAND memory) addressable by the host system via a storage access protocol (e.g., non-volatile memory express (NVMe)). To provide the host processor with access to the storage medium, the memory sub-system is configured with a second interface for a separate connection to the host processor.

For example, the memory sub-system can be configured to obtain, through the second interface, storage access commands from submission queues configured in cyclic buffers accessible to both the host system and the memory sub-system. For example, the cyclic buffers can be configured in a portion of the main memory of the host system, or in the random access memory of the memory device located outside of the memory sub-system, or in the memory space of the memory sub-system. The storage medium of the memory sub-system is configured to be addressed at a granularity level that is coarser than the random access memory. For example, the storage medium can be addressed at the LBA block size of 4096 bytes or 512 bytes. The random access memory is configured to be access at a byte level (e.g., one byte, 8 bytes, 16 bytes, 32 bytes), or at a cache line level (e.g., 128 bytes).

A storage access command (e.g., a read or write command) can identify a memory address for storing data to, or retrieving data from, a memory address identified by the storage access command. For example, a read command can specify the memory address as the destination to store the data to be read from the storage medium at a logical block addressing (LBA) address specified by the read command. For example, a write command can identify the memory address as the source where data can be retrieved for writing to the storage medium at a logical block addressing (LBA) address specified by the write command. The memory address identified in the storage access command can be optionally in the random access memory of the memory device located outside of the memory sub-system. While the memory sub-system is executing such a storage access command, the memory sub-system can use the first interface to store data to (or load data from) the memory device outside of the memory sub-system and concurrently using the second interface to retrieve another storage access command from a submission queue (or store a completion record for another storage access command to a completion queue) in the main memory (or another memory device located outside of the memory sub-system).

For example, a CXL or PCIe fabric can be used to connect a plurality of memory devices, the memory sub-system, and a host processor. The host processor can use the random access memory of the memory sub-system and/or the random access memory of the memory devices as a staging ground to assemble a block of data to be written into the storage medium of the memory sub-system, or to prefetch a block of data for selective accessing a portion of the block. Optionally, the host processor can also configure a submission queue and/or a completion queue for the memory sub-system in the random access memory of the memory sub-system and/or the random access memory of the memory devices. Such usages of the random access memory on a CXL or PCIe fabric can reduce the traffic to and/or from the main memory of the host processor, and/or improve the usage of the bandwidth of the main memory of the host processor (e.g., in applications involving an artificial neural network).

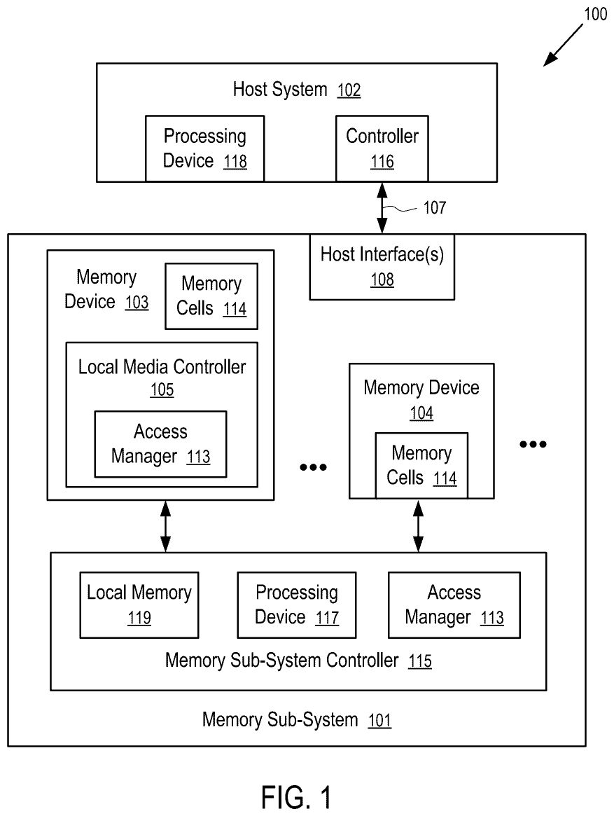

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include an access manager 113 configured to perform operations related to accessing a storage space of the memory sub-system 101. In some embodiments, the controller 115 in the memory sub-system 101 includes at least a portion of the access manager 113. In other embodiments, or in combination, the controller 116 and/or the processing device 118 in the host system 102 includes at least a portion of the access manager 113. For example, the controller 115, the controller 116, and/or the processing device 118 can include logic circuitry implementing the access manager 113. For example, the controller 115, or the processing device 118 (processor) of the host system 102, can be configured to execute instructions stored in memory for performing the operations of the access manager 113 described herein. In some embodiments, the access manager 113 is implemented in an integrated circuit chip disposed in the memory sub-system 101. In other embodiments, the access manager 113 can be part of firmware of the memory sub-system 101, an operating system of the host system 102, a device driver, or an application, or any combination therein.

For example, the access manager 113 implemented in the controller 115 and/or 105 of the memory sub-system 101 can be configured to expose a portion of the random access memory (e.g., local memory 119 and/or a subset of the memory devices 103 to 104) as a memory device attachable to the host system 102 during a boot time of the computing system 100. The memory space of the exposed portion of the random access memory can be added to the memory map of the host system 102 such that the memory controller 116 can access the memory space according to a standard for memory access (e.g., compute express link (CXL)) in response to execution of memory access instructions (e.g., store instructions, load instructions) in the processing device 118. The access manager 113 implemented in the computing system 100 can be configured to facilitate the access of the storage space provided by the non-volatile memory cells (e.g., 114 in one or more of the memory devices 103 to 104) using the memory space as a staging ground, as further discussed below. Alternatively, a memory device configured outside of the memory sub-system 101 can accessible via the host interface(s) 108 of the memory sub-system 101 can be used as the staging ground and/or a buffer memory for the storage space.

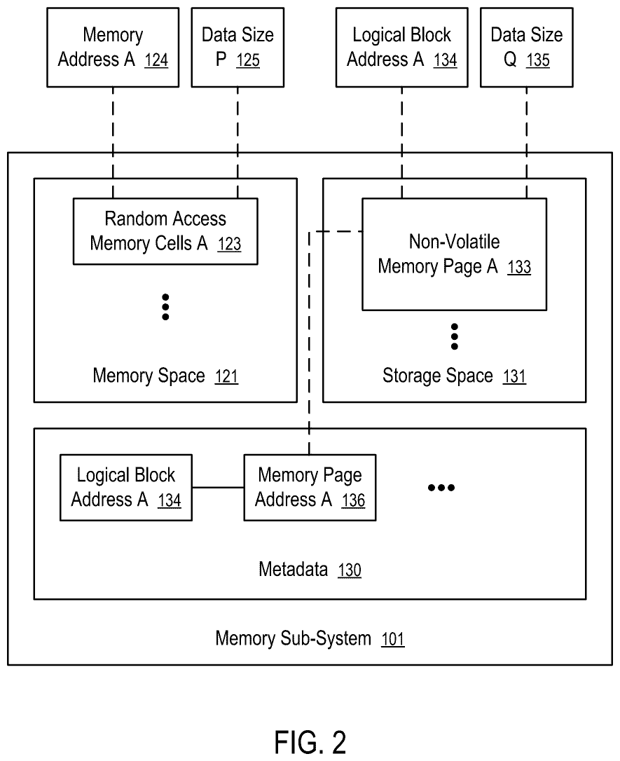

FIG. 2 shows a memory sub-system having a storage space and a memory space that are both accessible to a host system according to one embodiment. For example, the memory sub-system 101 in the computing system 100 of FIG. 1 can be implemented in a way as illustrated in FIG. 2.

In FIG. 2, the memory sub-system 101 includes a memory space 121 and a storage space 131 that is separate from the memory space 121. There is no overlapping area between the memory space 121 and the storage space 131.

For example, the memory space 121 can be implemented using memory cells 114 provided in a first subset of memory devices 103, . . . , 104 configured within the memory sub-system 101; and the storage space 131 can be implemented using memory cells in a second subset of the memory devices 103, . . . , 104. For example, there is no overlapping between the first subset and the second subset in some implementations.

For example, the first subset of the memory devices 103, . . . , 104 can have random access memory cells 123 operable and/or accessible at granularity of a smaller data size 125 (e.g., one byte, 16 bytes, or a cache line of 128 bytes). The second subset of the memory devices 103, . . . , 104 can have memory cells 114 configured as memory pages (e.g., 133) operable and/or accessible at granularity of a larger data size 135 (e.g., 512 bytes, or 1024 bytes, or 4096 bytes). For example, the capacity of the memory space 121 can be a fraction of the capacity of the storage space 131.

For example, the random access memory cells (e.g., 123) used to implement the memory space 121 can be volatile and faster in access than the memory pages (e.g., 133) used to implement the storage space 131. For example, the random access memory cells (e.g., 123) can be dynamic random access memory (DRAM), such as synchronous DRAM (SDRAM), or static random access memory (SRAM), etc.

For example, the memory cells 114 used to implement the memory pages (e.g., 133) in the storage space 131 can be non-volatile and slower in access than the random access memory cells (e.g., 123). For example, the memory pages (e.g., 133) can be implemented using flash memory (e.g., NAND memory, NOR memory).

A smallest portion of the memory space 121 that can be addressed by a host system (e.g., 102) for access using a load or store instruction and a memory address (e.g., 124) can be configured to have the data size 125. A memory address (e.g., 124) represents a unit of data storage capacity of the predetermined data size 125 in the memory space 121. The memory space 121 can be physically subdivided into units of the same predetermined data size 125 for addressing using memory addresses (e.g., 124). When a memory address 124 is provided for loading data from or for storing data into the memory space 121, the memory sub-system 101 can determine the unit of random access memory cells (e.g., 123) identified by the memory address (e.g., 124) without using a look up table. The memory address 124 can be fixedly associated with a unit of random access memory cells 123 in the memory sub-system 101. An operation to store data to the memory address 124 does not result in a change in the unit of random access memory cells 123 represented by the memory address 124. A host system (e.g., 102) can use a memory access protocol (e.g., CXL) to load data from, or store data to, the unit of random access memory cells (e.g., 123) represented by the memory address (e.g., 124) over a connection 107 between the host system (e.g., 102) and the memory sub-system 101. Optionally, the memory access protocol can be cache coherent.

A smallest portion of the storage space 131 that can be addressed by a host system (e.g., 102) for access using a read or write command and a logical block address (e.g., 134) can be configured to have the data size 135. For example, the logical block address (e.g., 134) can be an LBA address as in a standard for storage access protocol (e.g., NVMe). The logical block address (e.g., 134) represents a logical unit of data storage capacity of the predetermined data size 135 in the storage space 131. The storage space 131 is logically subdivided into units of the same predetermined data size 135 for addressing using logical block addresses (e.g., 134). The memory sub-system 101 stores metadata 130 containing a look up table configured to map logical block addresses (e.g., 134) to memory page addresses (e.g., 136). When a logical block address 134 is provided for reading data from or writing data into the storage space 131, the memory sub-system 101 can use the metadata 130 to determine the physical memory page address 136 to perform the read or write operation. To write data to the logical block address 134, the memory sub-system 101 can allocate a fresh memory page that is ready to be programmed to store data (e.g., a memory page of memory cells that are in an erased state), update the metadata 130 to map the logical block address 134 to the address of the allocated memory page, and programmed the memory cells in the allocated memory page to store the data. If the logical block address 134 is previously associated with a memory page address 136, the memory sub-system 101 can update the metadata 130 such that the logical block address 134 is no longer associated with the memory page address 136; and the memory sub-system 101 can further store data indicating that the memory cells at the memory page address 136 can be erased. To read data from the logical block address 134, the memory sub-system 101 uses the metadata 130 to determine the memory page address 136 currently associated with the logical block address 134 and perform operations to sense the states of memory cells in the memory page 133 identified by the memory page address 136 to determine the data represented by the states of the memory cells. Since the mapping between logical block addresses (e.g., 134) and memory page addresses (e.g., 136), as defined in the metadata 130, can change over time (e.g., in response to deletion data from logical block addresses and overwriting data to logical block addresses), a logical block address (e.g., 134) does not always represent a same physical memory page (e.g., 133) at a memory page address (e.g., 136) in the memory sub-system 101. An operation to write data to the logical block address 134 results in a change in the page 133 of non-volatile memory cells (e.g., 114) represented by the logical block address 134.

A host system (e.g., 102 as in FIG. 1) can use a storage access protocol (e.g., NVMe) to read data from, or write data to, the unit of non-volatile memory cells (e.g., in a memory page 133) currently represented by a logical block address 134 according to the metadata 130 stored in the memory sub-system 101. For example, the host system 102 can enter a read or write command in a cyclic buffer according to an NVMe protocol; and the memory sub-system 101 can retrieve the read or write command from the cyclic buffer for execution. The read command can identify a memory address as the destination for storing the data to be read from a logical block address (e.g., 134) specified in the read command; and the write command can identify a memory address as the source for retrieving of the data to be written to a logical block address (e.g., 134) specified in the write command. The memory sub-system 101 is configured to access the memory address identified in the read or write command during the execution of the read or write command.

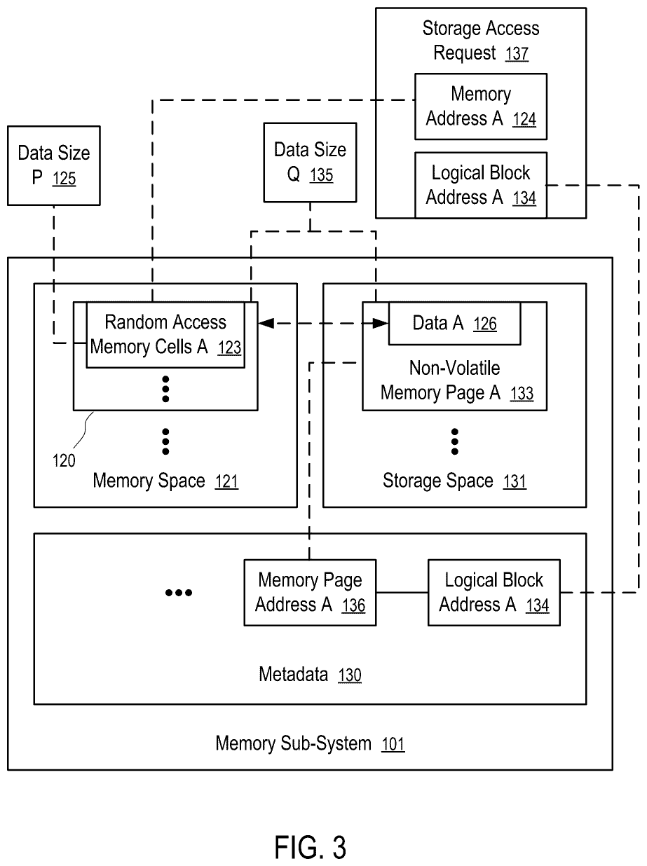

The memory sub-system 101 allows the host system to identify, in a read or write command, a memory address (e.g., 124) that represents a location in the memory space 121 within the memory sub-system 101. When such a read command having a memory address 124 is executed in the memory sub-system 101, the data retrieved from the logical block address 134 as identified in the read command is loaded into the memory space 121 within the memory sub-system 101; and none of the data retrieved from the logical block address 134 is communicated to outside of the memory sub-system 101 during the execution of the read command, as further discussed below in connection with FIG. 3. As a result, the execution of such a read command is reduced to an internal operation within the memory sub-system 101.

Similarly, when such a write command having a memory address 124 is executed in the memory sub-system 101, the data to be written into the storage space 131 at the logical block address 134 is retrieved from the memory space 121 within the memory sub-system 101; and none of the data being written to the logical block address 134 is communicated from outside of the memory sub-system 101 during the execution of the write command, as further discussed below in connection with FIG. 3. As a result, the execution of such a write command is reduced to an internal operation within the memory sub-system 101.

FIG. 3 shows a technique of using a storage access request to transfer data between a storage space and a memory space of a memory sub-system according to one embodiment, such as the memory sub-system 101 of FIG. 2.

In FIG. 3, a storage access request 137 is sent to the memory sub-system 101 to read data 126, or write data 126 to, a logical block address 134 in the storage space 131 of the memory sub-system 101. The storage access request 137 is configured to identify not only the logical block address 134 in the storage space 131 of the memory sub-system 101, but also a memory address 124 in the memory space 121 in the memory sub-system 101.

For example, the storage access request 137 can be a read command or a write command configured in accordance with a standard of non-volatile memory express (NVMe). When the storage access request 137 includes an opcode for a read operation, the storage access request 137 represents a read command; and when the storage access request 137 includes an opcode for a write operation, the storage access request 137 represents a write command.

When the storage access request 137 is a read command, the execution of the read command in the memory sub-system 101 causes the memory sub-system 101 to determine, using the metadata 130, the memory page address 136 that is associated with the logical block address 134 in the metadata 130. Using the memory page address 136, the memory sub-system 101 performs the read operation on the memory page 133 to retrieve the data 126 programmed into the memory cells (e.g., 114) in the memory page 133. For example, the read operation can include applying read voltages to the memory cells (e.g., 114) in the memory page 133 to determine the states of the memory cells (e.g., 114). For example, when a read voltage is applied to a memory cell 114, the memory cell 114 can have a state of allowing more than a threshold amount of current to go through the memory cell 114, or a state of allowing a negligible amount of current to go through the memory cell 114. Optionally, a plurality of different read voltages can be applied to determine the states of the memory cell 114 at the respective read voltages. The data having been programmed into the memory cell 114 can be determined based on the states of the memory cells 114 at the read voltages. In some implementations, a single memory cell can be programmed to store data having more than one bit.

After determining the data 126 stored in the memory page 133, the memory sub-system 101 can store the data into a block 120 of random access memory cells (e.g., 123) in the memory space 121. Optionally, the memory sub-system 101 can update the metadata 130 to indicate that the data of the logical block address 134 now resides (or has a cached/buffered version) in the memory space 121 at the memory address 124. The block 120 of memory cells has a plurality of units of memory cells (e.g., 123), where each unit of memory cells (e.g., 123) is represented by one memory address (e.g., 124) in the memory space 121. Thus, the data at one logical block address 134 in the storage space 131 is read internally within the memory sub-system 101 into the memory space 121 at a plurality of memory addresses (e.g., 124).

The block 120 of random access memory cells used to store the data 126 retrieved from the logical block address 134 can be identified based on the memory address 124 specified in the read command and the data size 135 of the block of data 126 stored in the memory page 133. For example, the block 120 of random access memory cells (e.g., 123) can start with the unit of memory cells 123 at the memory address 124 specified in the storage access request 137. The unit of the memory cells 123 can hold the beginning portion of the data 126 according to the data size 125. Multiple contiguous units of memory cells (e.g., 123) having consecutive memory addresses (e.g., 124) in the memory space 121 can be used to store respective portions of the data 126 retrieved from the logical block address 134.

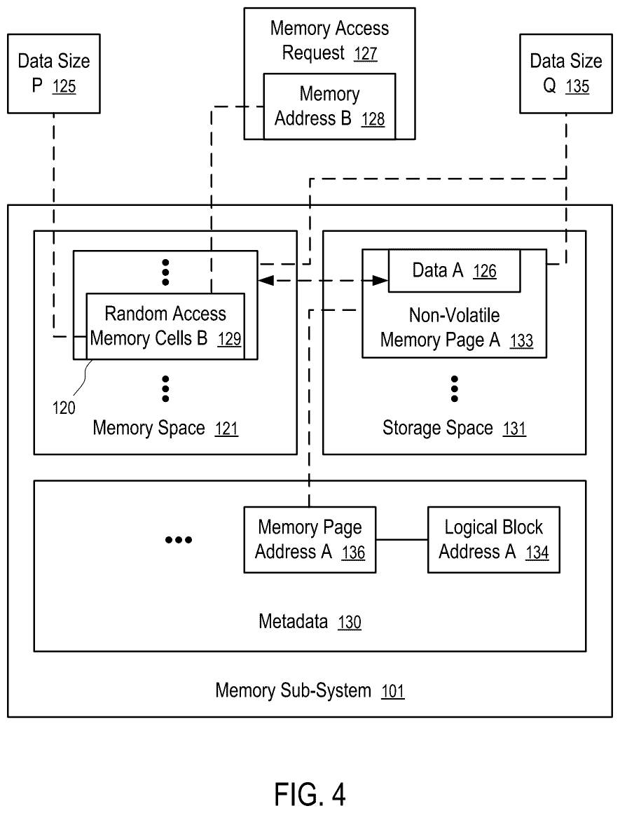

Once the data 126 is in the block 120 of random access memory cells (e.g., 123) in the memory space 121, the host system 102 can use a memory access protocol (e.g., compute express link (CXL) or peripheral component interconnect express (PCIe)) to access any portion(s) of the data 126 using one or more of the memory addresses (e.g., 124) in the block 120, without communicating the remaining portion(s) of the block 120 across the connection 107 between the memory sub-system 101 and the host system 102. For example, the host system 102 can use the block 120 of the memory space 121 as a staging ground to buffer the data 126 from the storage space 131 and access the memory space 121 for a selected portion of the data 126 at a time when the selected portion is about to be used in computations. Since the latency of loading data from the memory space 121 is significantly lower than the latency of reading data (e.g., 126) from the storage space 131, the host system 102 can predicatively retrieve data from the storage space 131 into the memory space 121 using the storage access request 137 and then load one or more portions of the data 126 from the memory space 121 at the time when the portions are need for computation in the host system 102 (e.g., as in FIG. 4)

Optionally, the host system 102 can use store instructions to store data to one or more portions of the block 120 of random access memory cells (e.g., 123) and thus modify the block of data 126 retrieved from the storage space 131 (e.g., as in FIG. 4). Subsequently, the host system 102 can use a write command to write the modified block of data to the storage space 131.

When the storage access request 137 is a write command, the execution of the write command in the memory sub-system 101 causes the memory sub-system 101 to program the data 126 in the block 120 of the memory space into a memory page 133 in the storage space 131. For example, if the logical block address 134 is associated with a memory page address 136 prior to the execution of the write command, the memory sub-system 101 can store data to indicate that the memory page 133 at the memory page address 136 can be erased. To execute the write command, the memory sub-system 101 allocates a fresh memory page that is ready for being programmed to store data (e.g., a memory page having memory cells in a state of being erased) and update the metadata 130 to associate the logical block address 134 with the memory page address of the allocated fresh memory page. The memory sub-system 101 can perform the write operation on the allocated fresh memory page such that during a read operation, the states of the memory cells in the memory page as programmed can be sensed to provide the same data 126 as being written via the write operation.

FIG. 4 shows a technique of using a memory access request for data transferred between a storage space and a memory space of a memory sub-system according to one embodiment.

For example, after a storage access request 137 (e.g., a read command) is executed in the memory sub-system 101 as in FIG. 3, the data 126 in a logical block address 134 is copied to a block 120 of random access memory cells (e.g., 123, 129) identified via a memory address 124 specified in the storage access request 137. The block 120 of random access memory cells contain a plurality of units of memory cells. Each unit of memory cells (e.g., 123 or 129) has a separate memory address (e.g., 124 or 128). A host system (e.g., 102 as in FIG. 1) can use one of the memory addresses (e.g., 128) in the block 120 to access a respective portion of the data 126 stored in one of the units of memory cells (e.g., 129).

For example, a processing device 118 in the host system 102 can execute a load instruction to cause a memory controller 116 in the host system 102 to generate a memory access request 127 containing a memory address 128 to load data from the block 120 of memory cells 129 in the memory space 121 to the host system 102. In response to the memory access request 127 identifying the memory address 128, the memory sub-system 101 can provide data from a respective unit of memory cells 129 represented by the memory address 128 over the connection 107 to the host system 102.

For example, the memory access request 127 can be in accordance with a standard for compute express link (CXL) or peripheral component interconnect express (PCIe) over a PCIe connection 107 between the host system 102 and the memory sub-system 101.

In general, the memory access request 127 can specify any of the memory addresses (e.g., 124, 128) in the block 120 of memory cells to access a corresponding portion of the data 126 that is stored in a block of storage space 131 represented by a single logical block address 134. Thus, the combination of storage access request 137 and the memory access request 127 allows the host system 102 to load a sub block of the block of data 126, where the size of the sub block corresponds to the data size 125 for memory access.

Optionally, the processing device 118 in the host system 102 can execute a store instructions to cause the memory controller 116 to generate a memory access request 127 to store data to the memory address 128. Thus, a sub block of the block of data 126 as in the unit of memory cells 129 in the block 120 can be modified via the memory access request 127. Optionally, the host system 102 can use the block as a staging ground to build and/or modify the entire content in the block 120 such that a subsequent storage access request (e.g., 137 as in FIG. 3) can be used to write the content from the block 120 to a logical block address (e.g., 134) in the storage space 131 of the memory sub-system 101.

Using the techniques of FIG. 3 and FIG. 4, a host system 102 can efficiently access sub blocks of an LBA block in a storage space 131 configured in the memory sub-system 101 without a need to allocate extra memory in the host system 102 to store the entire LBA block at once and/or without communicating sub blocks of the LBA block that are not going to be used in the computations performed in the host system 102.

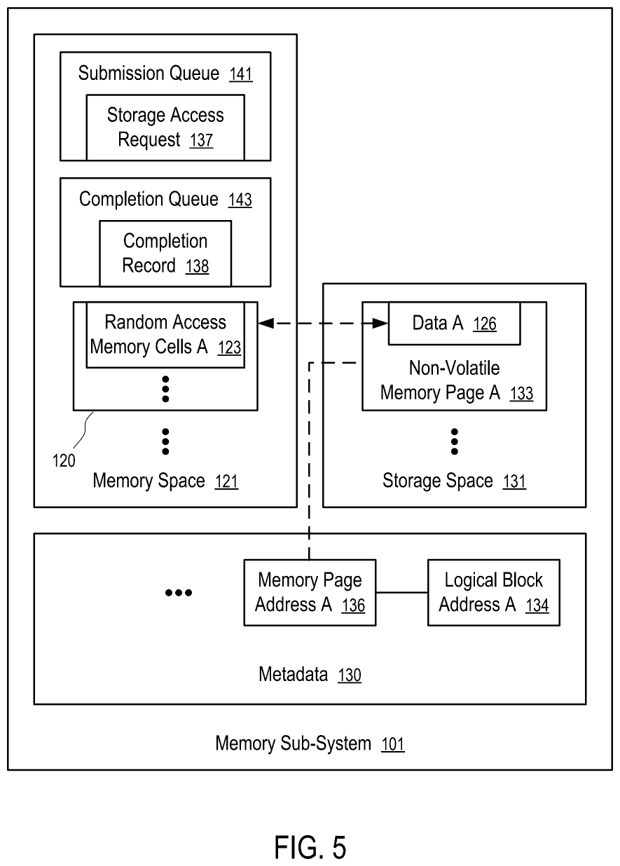

FIG. 5 to FIG. 7 show techniques to cause a memory sub-system to transfer data between a storage space of the memory sub-system and a memory space of the memory sub-system according to some embodiments.

In FIG. 5, a pair of a submission queue 141 and a completion queue 143 are configured in the memory space 121 of the memory sub-system 101 during a boot time of the computing system 100 containing the host system 102 and the memory sub-system 101.

For example, the submission queue 141 and the completion queue 143 can be configured as cyclic buffers according to an NVMe standard. The host system 102 can use a memory access protocol to store a storage access request 137 into the submission queue 141. The storage access request 137 can specify a memory address (e.g., 124) and a logical block address (e.g., 134) as in FIG. 3 for execution by the memory sub-system 101. The memory sub-system 101 can retrieve the storage access request 137 for execution (e.g., as in FIG. 3). Upon completion of the execution of the storage access request 137 (e.g., a read command or a write command as discussed in connection with FIG. 3), the memory sub-system 101 can generate a completion record 138 in the completion queue 143. The completion record 138 can identify the completion status of the storage access request 137. The host system 102 can retrieve the completion record 138 from the completion queue 143 using the memory access protocol.

For example, when the completion record 138 indicates that the read operation of the storage access request 137 is complete, the host system 102 knows that the data 126 is now available in the block 120 of memory cells at a location starting with the memory address 124 specified in the storage access request 137. Thus, a load instruction can be executed subsequently to load a sub block of the data 126 from a memory address (e.g., 128) in the memory space 121.

For example, when the completion record 138 indicates that the write operation of the storage access request 137 is complete, the host system 102 knows that the data 126 is now stored in the logical block address 134 specified in the storage access request 137. Thus, the host system 102 can reuse the block 120 of random access memory cells for other operations, such as building up another block of data, or load data from another logical block address in the storage space 131 into the block 120 in the memory space 121.

When the submission queue 141 and the completion queue 143 are both configured in the memory sub-system 101 (e.g., as in FIG. 5), it is not necessary to configure the memory sub-system 101 with capabilities to access random access memory outside of the memory sub-system 101.

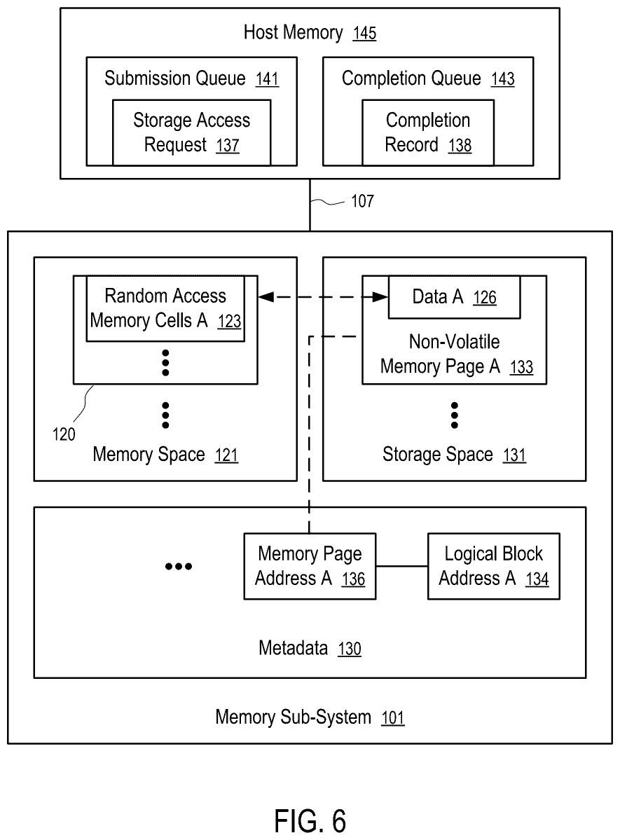

In FIG. 6, a pair of a submission queue 141 and a completion queue 143 are configured in the host memory 145 outside of the memory sub-system 101 during a boot time of the computing system 100 containing the host system 102 and the memory sub-system 101. For example, the host memory 145 can be the main memory of the host system 102 and/or the processing device 118 of the host system 102, or another random access memory that is added to the memory map of the host system 102 during the boot time of the computing system 100.

The memory sub-system 101 is configured to use a memory access protocol (e.g., in accordance with a standard for compute express link (CXL) or peripheral component interconnect express (PCIe) over a PCIe connection 107 between the host system 102 and the memory sub-system 101) to access the host memory 145. For example, the memory sub-system 101 can include a direct memory access (DMA) engine configured to retrieve data from the host memory 145, such as the storage access request 137 provided by the host system 102 in the submission queue 141 (e.g., to specify a memory address 124 and a logical block address 134 in a way as in FIG. 3). As in FIG. 5, after the completion of the execution of the storage access request 137 in the memory sub-system 101, the memory sub-system 101 can use the memory access protocol to enter a completion record 138 in the completion queue 143.

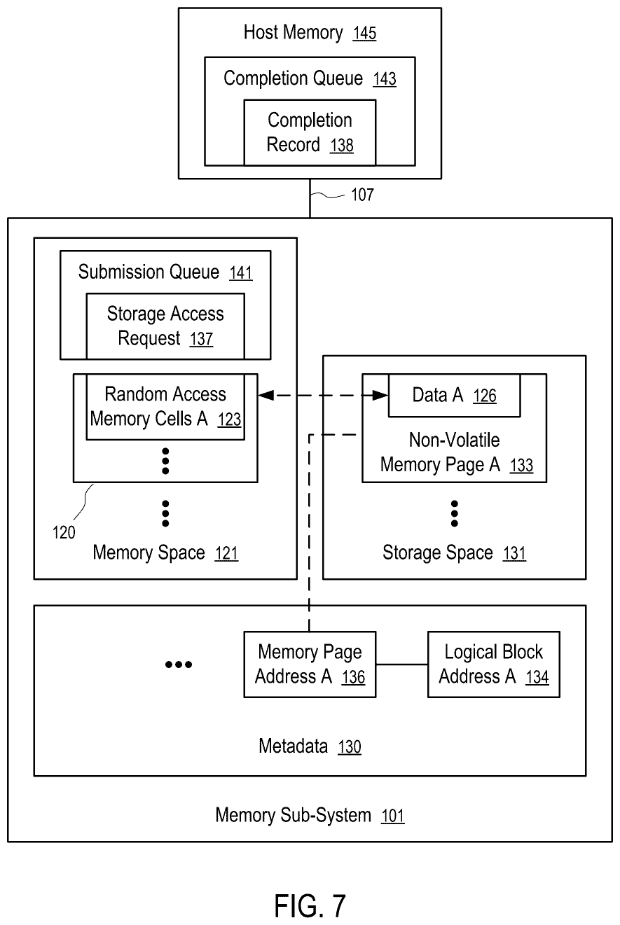

In FIG. 7, the submission queue 141 for storage access requests (e.g., 137) having memory addresses (e.g., 124) in the memory space 121 and/or logical block addresses (e.g., 134) in the storage space 131 is configured in the memory space 121 of the memory sub-system 101 (e.g., as in FIG. 5); and the completion queue 143 is configured in a host memory 145 (e.g., as in FIG. 6). When the memory sub-system 101 detects the writing of a storage access request 137 into the submission queue 141 configured in the memory space 121 of the memory sub-system 101, the memory sub-system 101 can retrieve the request 137 in response, which arrangement can reduce or eliminated the need for the memory sub-system 101 to poll the submission queue 141 regularly to determine whether there is a pending request in the submission queue 141. Similarly, when the host system 102 detects the writing of a completion record 138 in the completion queue 143, the host system 102 can retrieve the record 138 in response, which arrangement can reduce or eliminated the need for the host system 102 to poll the completion queue 143 to determine whether there is a record in the completion queue 143.

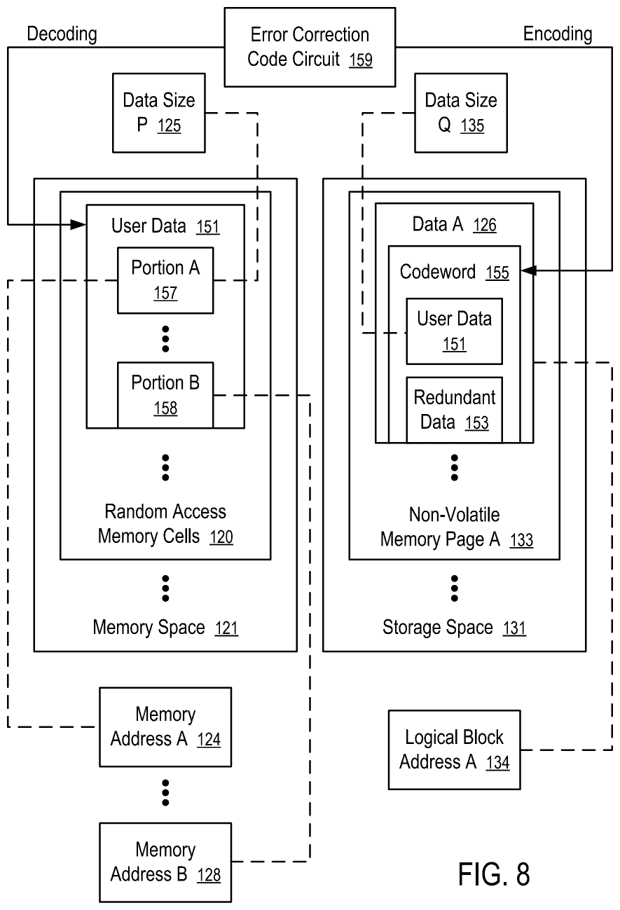

FIG. 8 shows error correction encoding and decoding for data transfers between a storage space and a memory space of the memory sub-system according to one embodiment. For example, the data transfer between a storage space 131 and a memory space 121 as discussed in connection with FIG. 3 to FIG. 7 can include the error correction operations of FIG. 8.

In FIG. 8, a codeword 155 includes user data 151 and redundant data 153. The codeword 155 is stored as the data 126 in a memory page 133 that corresponds to a logical block address 134 according to metadata 130. When the memory sub-system 101 performs a read operation on the memory page 133 to determine the data 126 via sensing the states of memory cells in the memory page 133, the result of the sensing operation can have one or more random bit errors in the portion representing the user data 151 and/or the portion representing the redundant data 153.

An error correction code circuit 159 of the memory sub-system 101 can perform a decoding operation of an error correction code technique (e.g., low-density parity-check (LDPC)) to detect the random bit errors and correct the errors to recover an error-free version of the user data 151 into the block of random access memory cells 120 in the memory space 121.

The decoding operation is configured to operate the retrieved version of the data 126 or codeword 155 retrieved from the memory page 133 as a whole. The memory sub-system 101 and/or the error correction code circuit 159 cannot perform the decoding operation on a portion of the data 126 or codeword 155 to recover an error-free version of only a portion of the user data 151. Thus, to determine an error-free version of any portion of the user data 151 stored in the storage space 131, the entire codeword 155 is sensed and decoded to store the error-free version of the user data 151 in the memory space 121.

The memory cells (e.g., DRAM or SDRAM cells) used to implement the memory space 121 can be more reliable in data storage and retrieval than the memory cells (e.g., NAND or NOR cells) used to implement the storage space 131. Thus, the block 120 of random access memory cells can be configured to store the user data 151 but not the redundant data 153.

Optionally, an error detection and/or correction technique can also be used to detect and/or correct random bit errors in data retrieved from the memory space 121. However, the error detection and/or correction technique can be applied separately for different portions 157, . . . , 158 of the user data 151 stored in the memory space 121, such that the decoding is not dependent on the retrieval of the user data 151 from the block 120 of the random access memory cells as a whole. Instead, the error detection and/or correction technique can be applied to any of the portions 157, . . . , 158 of the user data 151. The portions 157, . . . , 158 of the user data 151 at the memory addresses 124, . . . , 128 respectively can be retrieved separately with error detection and/or correction. Thus, the memory sub-system 101 can retrieve a portion (e.g., 157 or 158) of the user data 151 according to a memory address (e.g., 124 or 128) without retrieving other portions of the user data 151 from the memory space 121.

To write the user data 151 in the memory space 121 to the storage space 131 at the logical block address 134, the error correction code circuit 159 can perform an encoding operation of the error correction code technique (e.g., low-density parity-check (LDPC)) to generate the codeword 155 containing both the user data 151 and the redundant data 153. The memory cells in the memory page 133 are programmed to have states representing the bits of the codewords 155.

The user data 151 can have the data size 135 representative of the capacity to store data for a user at a logical block address 134 in the storage space 131. Each portion (e.g., 157 or 158) of the user data 151 can have the data size 125 representative of the capacity to store data for a user at a memory address (e.g., 124 or 128) in the memory space 121. The data size 135 can be configured as a predetermined multiple of the data size 125. For example, the data size 135 can be 512 bytes, 1024 bytes, 2048 bytes, or 4096 bytes; and the data size 125 can be one byte, 8 bytes, 16 bytes, 32 bytes, 64 bytes, or 128 bytes.

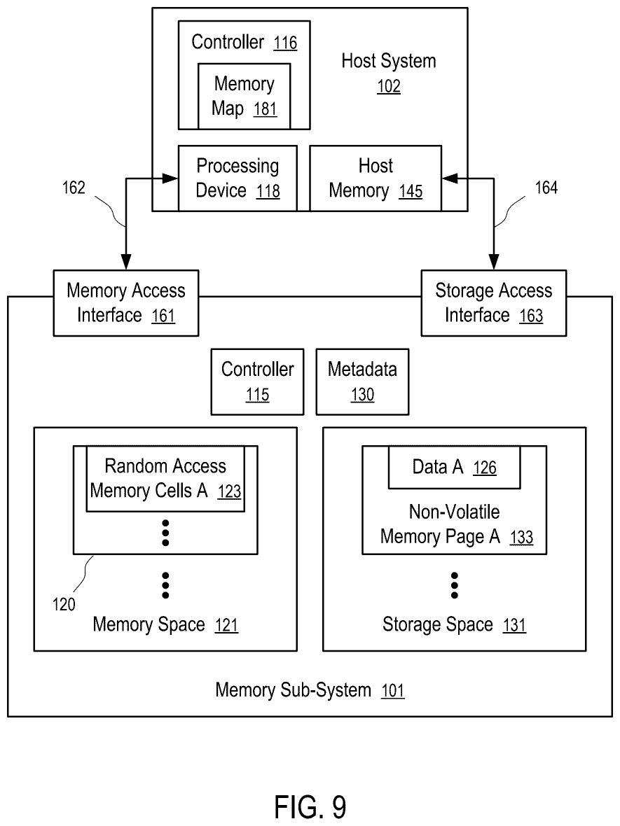

FIG. 9 to FIG. 13 show configurations of a memory sub-system having one or more connections to a host system for storage access and memory access according to some embodiments. For example, the memory sub-system 101 in FIG. 1 to FIG. 8 can be configured with one or more host interfaces according to any of FIG. 9 to FIG. 13.

A typical host system (e.g., 102 in FIG. 1 and FIG. 9) can have a memory controller 116 configured to access memory addresses identified as being accessible in a memory map 181. For example, during a boot time, the computing system 100 can determine memory devices (e.g., the main memory of the processing devices 118, host memory 145, and/or the memory space 121 offered by the memory sub-system 101 as a memory device) that are accessible and/or attached to the processing devices 118 in the computing system 100. The memory map 181 can identify the physical memory addresses of the random access memory in the memory devices detected during the boot time of the computing system 100. The memory controller 116 can map the virtual memory addresses used in the processing devices 118 into the physical memory addresses to access memory when the processing devices 118 execute memory access instructions (e.g., load instructions, store instructions) that identify the virtual memory addresses being accessed.

In FIG. 9, the memory sub-system 101 includes a memory access interface 161 and a storage access interface 163. The memory access interface 161 is connected to the host system 102 via a connection 162; and the storage access interface 163 is connected to the host system 102 via a connection 164 that is separate from the connection 162 to the memory access interface 161.

The memory access interface 161 can be configured to allow a processing device(s) 118 in the host system 102 to access the memory space 121 efficiently with reduced latency. The processing device(s) 118 in the host system 102 can execute load instructions and store instructions to initiate communications over the connection 162 to the memory access interface 161 to load data from and store data to the memory space 121 using a memory access protocol (e.g., in compliance with a standard of compute express link (CXL), peripheral component interconnect express (PCIe), double data rate (DDR)).

The storage access interface 163 can be configured to facilitate communicate storage access communications (e.g., in compliance with standard of non-volatile memory express (NVMe)). For example, the connection 164 can be configured to allow the controller 115 (or a direct memory access (DMA) engine) of the memory sub-system 101 to access, via the connection 164, the host memory 145 to receive storage access requests (e.g., 137) from a submission queue (e.g., 141) configured in the host memory 145 (e.g., as in FIG. 6), to provide completion records (e.g., 138) into a completion queue 143 configured in the host memory 145 (e.g., as in FIG. 6 and FIG. 7), to retrieve data from memory addresses that are in the host memory 145 as specified in storage access requests having the opcode for write operations, and/or to provide data to memory addresses that are in the host memory 145 as specified in storage access requests having the opcode for read operations.

Optionally, the connections 162 and 164 are of different types. For example, in one implementation, the connection 162 is a DDR bus; and the connection 164 is a PCIe bus; and in another implementation, the connection 162 is a PCIe bus or CXL connection; and the connection 164 is a network connection. Optionally, the connection 162 can be configured to have a higher bandwidth and a lower latency in communications than the connection 164. Alternatively, the connections 162 and 164 can be of a same type (e.g., a PCIe or CXL connection) and/or can be used interchangeably for memory access and for storage access.

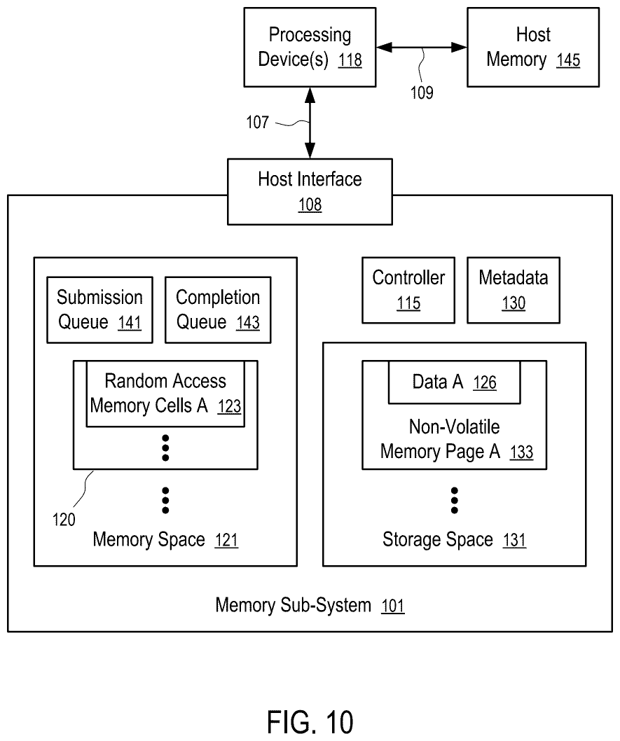

Alternatively, the memory access and the storage access can be made using a same interface over a same connection (e.g., a PCIe bus or CXL connection) to the host system 102, as in FIG. 10.

In FIG. 10, a host interface 108 is configured to allow the processing device(s) 118 (e.g., a CPU, a GPU, a CPU or GPU core, or a system on a chip (SoC), or an AI accelerator) to access the memory space 121 over a connection 107. The processing device(s) 118 can be configured to specify memory addresses (e.g., 124) used in storage access requests (e.g., 137) in the memory space 121. The submission queue 141 and the completion queue 143 can be both configured in the memory space 121 (e.g., as in FIG. 5). Thus, it is not necessary for the memory sub-system 101 to access the host memory 145; and the host memory 145 can be connected to the processing device(s) 118 via a connection 109 that is separate from the connection 107 between the processing device(s) 118 and the memory sub-system 101. For example, the connection 107 can be a PCIe bus, CXL connection, or a DDR bus.

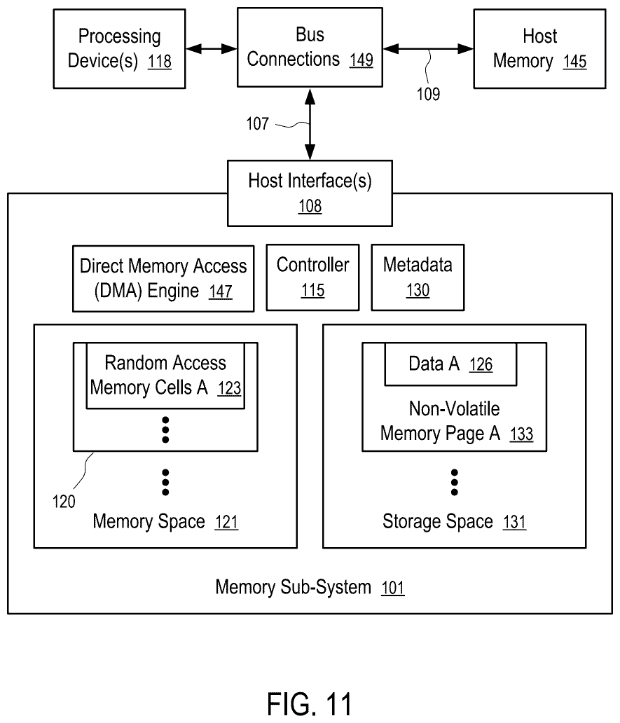

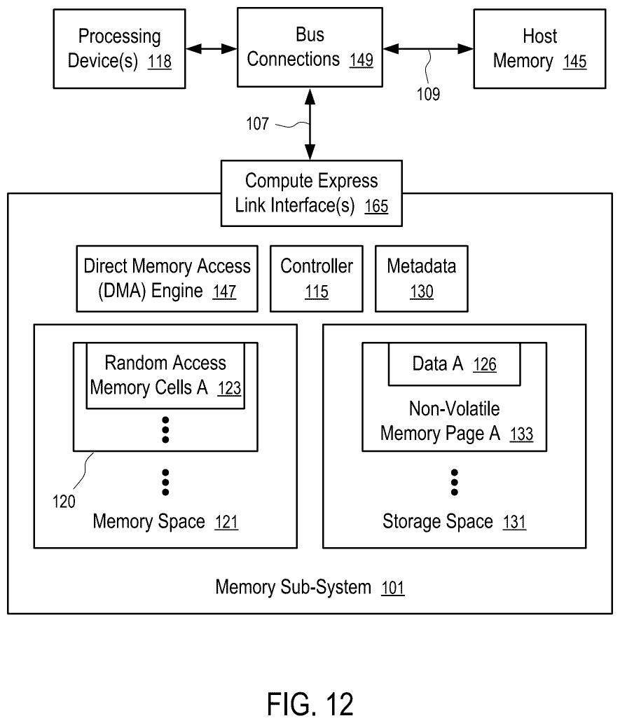

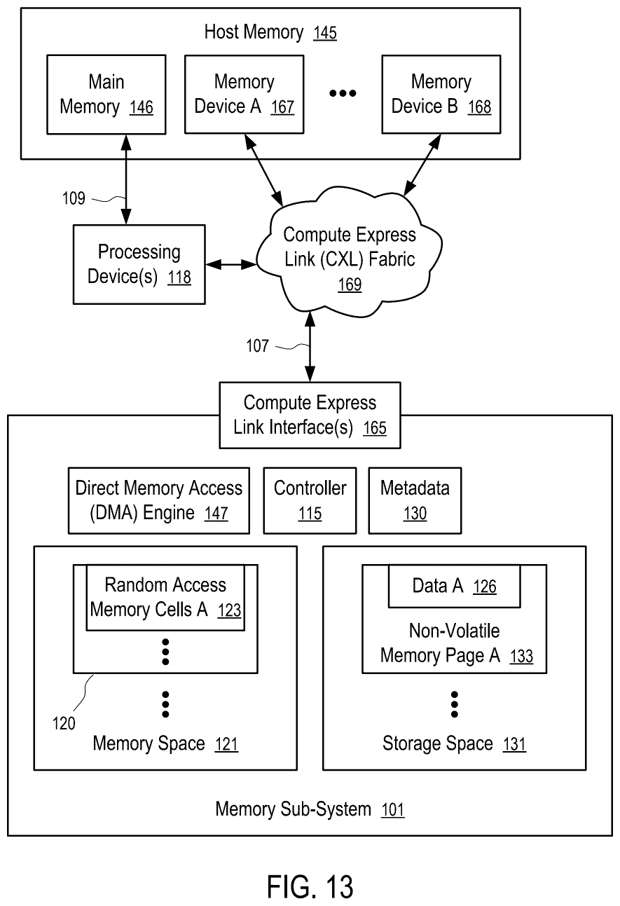

Alternatively, the memory sub-system 101 can be configured to include one or more host interface(s) 108 that can be used by the processing devices 118 to load data from and store data to the memory space 121 and concurrently used by a direct memory access (DMA) engine 147 and/or the controller 115 of the memory sub-system 101 to access the host memory 145, as in FIG. 11, FIG. 12, and FIG. 13.

In FIG. 11, a set of bus connections 149 can be configured to interconnect the processing device(s) 118, the host memory 145, and the host interface(s) 108 of the memory sub-system 101. Since the host interface(s) 108 allows the processing device(s) 118 to load data from and store data to the memory space 121, some submission queues can be configured for the memory sub-system 101 in the memory space 121 of the memory sub-system 101. Optionally, some submission queues and/or completion queues can be configured for the memory sub-system 101 in the host memory 145 outside of the memory sub-system 101. The processing device(s) 118 can configure storage access requests (e.g., 137) to have memory addresses (e.g., 124) in the memory space 121 or in the host memory 145. Thus, the source of the data to be written into the storage space 131 via write commands can be in the memory space 121 or in the host memory 145 during the execution of the write commands (e.g., storage access requests 137); and the destination of the data to be retrieved from the storage space 131 via read commands can be in the memory space 121 or in the host memory 145 during the execution of the read commands (e.g., storage access requests 137).

At least one of the host interface(s) 108 in FIG. 11 can be configured to allow the direct memory access engine 147 of the memory sub-system 101 to access the host memory 145 without assistance from the processing devices 118. Thus, the processing device(s) 118 can optionally configure some storage access requests to have memory addresses in the host memory 145. For example, data to be written into the storage space 131 can be in the host memory 145 for the execution of such storage access requests having opcodes for write operations. For example, data to be retrieved from the storage space 131 can be retrieved into the host memory 145 for the execution of such storage access requests having opcodes for read operations. Further, submission queues and/or completion queues for the memory sub-system 101 can be configured in the host memory 145. The controller 115 and/or the direct memory access (DMA) engine 147 can be configured to access the submission queues and/or completion queues that are in the host memory 145.

In some implementations, the memory sub-system 101 includes multiple host interfaces 108 to allow concurrent access by the processing device(s) 118 to the memory space 121 and by the memory sub-system 101 to the host memory 145. Alternatively, the memory sub-system 101 has a single host interface 108 for a connection (e.g., PCIe or CXL connection) that allows the memory sub-system 101 to the host memory 145 during some time periods and the processing device 118 to access the memory space 121 during other time periods (but not concurrently).

Optionally, the host interface(s) 108 can be compute express link interface(s) 165 as in FIG. 12.

For example, at least one of the compute express link interface(s) 165 in the memory sub-system 101 in FIG. 12 can be configured to allow the memory space 121 to be attached to the processing device 118 as a memory device; and at least one of the compute express link interface(s) 165 in the memory sub-system 101 in FIG. 12 can be configured to allow the DMA engine 147 and/or the controller 115 of the memory sub-system 101 to access at least a portion of the host memory 145. In some implementations, the memory sub-system 101 is configured with a single compute express link interface 165.

In some implementations, the compute express link interface(s) 165 can be connected to a compute express link (CXL) fabric 169 to allow the memory sub-system 101 to access other memory devices connected to the CXL fabric 169, as in FIG. 13.

The host memory 145 in FIG. 13 can include a main memory 146 connected to the processing device(s) 118 via a memory bus 109 (e.g., DDR memory bus). The host memory 145 can further include one or more memory devices 167, . . . , 168 configured outside of the memory sub-system 101 and connected to the memory sub-system 101 and the processing device(s) 118 via a compute express link (CXL) fabric 169. The CXL fabric 169 can interconnect the memory devices 167, . . . , 168, the memory sub-system 101, and the processing device(s) 118 to allow both the memory sub-system 101 and the processing device(s) 118 to access the memory devices 167, . . . , 168 concurrently.

For example, during the boot time of the computing system 100 containing the CXL fabric 169, the memory space 121 can be identified as one of the memory devices connected to the CXL fabric 169 and thus accessible to the processing device 118 using a memory access protocol of CXL. Thus, the physical memory addresses in the memory space 121 in the memory sub-system 101 and in the memory devices 167, . . . , 168 can be added to the memory map 181 of the memory controller 116 of the processing device(s) 118. Optionally, one or more of the memory devices 167, . . . , 168 can each corresponding to a memory space provided by a memory sub-system that is similar to the memory sub-system 101. Optionally, the main memory 146 is separately connected to the processing device(s) 118 (e.g., via a connection 109, such as a DDR memory bus); and the memory sub-system 101 is configured to access the main memory 146 via a memory controller 116 of the processing device(s) 118.

The CXL fabric 169 can include one or more CXL switches; and each of the memory devices 167, . . . , 168 and the memory sub-system 101 can have a separate CXL connection to one of the ports of the CXL switch(es) in the CXL fabric 169. Further, each of the processing device(s) 118 can have a separate CXL connection to one of the ports of the CXL switch(es) in the CXL fabric 169 to access the memory devices on the CXL fabric 169, including the memory devices 167, . . . , 168, and the memory device corresponding to the memory space 121 in the memory sub-system 101. The CXL fabric 169 can support concurrent access by different host processors (e.g., processing device(s) 118, direct memory access (DMA) engine 147, controller 115) to the memory devices on the CXL fabric 169. The memory sub-system 101 can have a plurality of parallel CXL connections 107 to the CXL fabric 169. Thus, while one or more processing devices 118 are accessing the memory space 121 of the memory sub-system 101 using a CXL memory access protocol, the DMA engine 147 of the memory sub-system 101 can use a separate CXL connection to the CXL fabric 169 to access one of the memory devices 167, . . . , 168. Thus, the submission queue 141 and the completion queue 143 of the memory sub-system 101 and/or memory addresses (e.g., 124) used in storage access requests (e.g., 137) in the submission queue 141 can be distributed in the memory devices on the CXL fabric 169, including the memory devices 167, . . . , 168, and the memory device corresponding to the memory space 121 of the memory sub-system 101.

For example, the processing device(s) 118 can configure a submission queue 141 for the memory sub-system 101 in the memory space 121, and/or another submission queue 141 for the memory sub-system 101 in one of the memory devices 167, . . . , 168 outside of the memory sub-system 101. A storage access request 137 entered in a submission queue (e.g., 141) for execution in the memory sub-system 101 can be configured with a memory address 124 in the memory space 121, or in one of the memory devices 167, . . . , 168. Thus, during the execution of the storage access request 137 having an opcode for reading from a logical block address 134, the memory sub-system 101 can retrieve data from the logical block address 134 into the memory space 121, or into the memory devices 167, . . . , 168, in accordance with the memory address 124 provided in the storage access request 137. Similarly, during the execution of the storage access request 137 having an opcode for writing to a logical block address 134, the memory sub-system 101 can retrieve data using the direct memory access (DMA) engine 147, from the memory space 121, or from the memory devices 167, . . . , 168, in accordance with the memory address 124 provided in the storage access request 137 for writing into a memory page 133 represented by the logical block address 134.

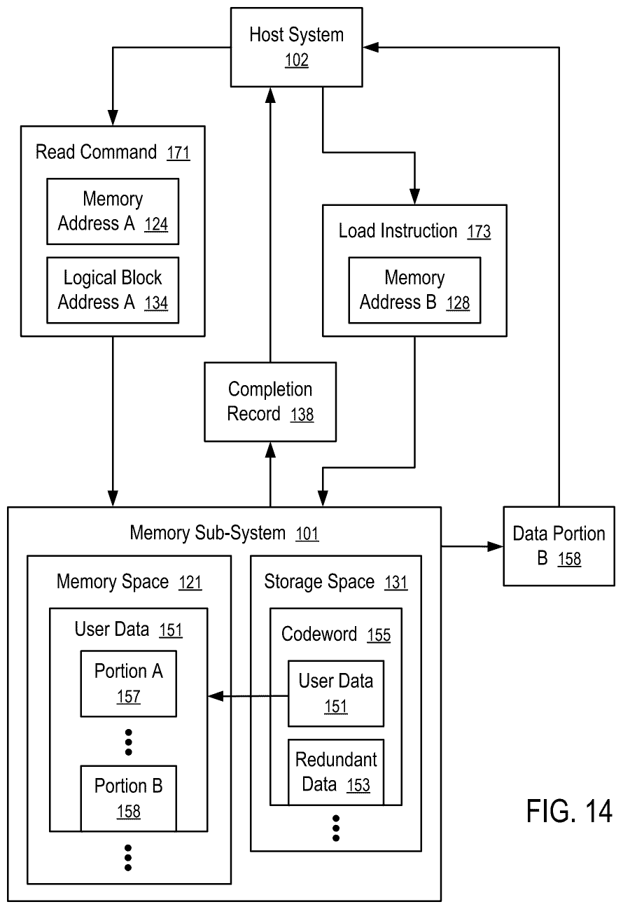

FIG. 14 shows communications to load a portion of data stored at a logical block address in a memory sub-system to a host system according to one embodiment. For example, communications can be implemented in a computing system 100 of FIG. 1 having a memory sub-system 101 according to FIG. 2 to FIG. 8 and connected according to FIG. 9 to FIG. 13.

As illustrated in FIG. 14, to access a portion 158 (e.g., a sub block) of data 151 stored at a logical block address 134 (e.g., an LBA address in accordance with an NVMe standard) in a storage space 131 of the memory sub-system 101, the host system 102 configures a read command 171 to have a memory address 124 in the memory space 121 of the memory sub-system 101, in addition to identifying the logical block address 134 in the storage space 131. The memory address 124 specified in the read command 171 is used to identify the destination location for the retrieval of the data 151 at the logical block address 134.

The host system 102 can send the read command 171 to the memory sub-system 101 using a storage access protocol (e.g., in accordance with an NVMe standard). For example, the host system 102 can enter the read command 171 as a storage access request 137 in a submission queue 141 for retrieval by the memory sub-system 101 (e.g., in accordance with an NVMe standard). For example, the submission queue 141 can be configured in the memory space 121 of the memory sub-system 101 (e.g., as in FIG. 5 or FIG. 7), or in the host memory 145 (e.g., as in FIG. 6). For example, the submission queue 141 can be configured in a memory device (e.g., 167 or 168) connected to a portion of a CXL fabric 169 as in FIG. 13.

The execution of the read command 171 in the memory sub-system 101 causes the memory sub-system 101 to retrieve, from the logical block address 134, a codeword 155 (e.g., encoded using an error correction code technique to have redundant data 153), decode the codeword 155 to determine an error-free version of the user data 151, and store the error-free version of the user data 151 in the memory space 121 according to the memory address 124.

Since the data size 135 of the user data 151 at the logical block address 134 is a multiple of the data size 125 at each memory address (e.g., 124, . . . , 128) in the memory space 121, the user data 151 occupies a plurality of memory addresses (e.g., 124, . . . , 128) in the memory space 121.

After the execution of the read command 171 in the memory sub-system 101, the entire block of user data 151 retrieved from the logical block address 134 is available in the memory space 121 (e.g., as in FIG. 3 to FIG. 8). The memory sub-system 101 can send a completion record 138 to the host system 102 (e.g., in accordance with an NVMe standard) to indicate the availability of the user data 151 in the memory space 121.

For example, the host system 102 can enter the completion record 138 in a completion queue 143 for retrieval by the host system 102. For example, the completion queue 143 can be configured in the memory space 121 of the memory sub-system 101 (e.g., as in FIG. 5), or in the host memory 145 (e.g., as in FIG. 6 or FIG. 7). For example, the completion queue 143 can be configured in a memory device (e.g., 167 or 168) connected to a portion of a CXL fabric 169 as in FIG. 13.

When the completion record 138 indicates a successful execution of the read command 171, any portion (e.g., 157, . . . , 158) in the user data 151 can be loaded from the memory space 121 to the host system 102 via the execution of a load instruction 173 in the host system 102.

For example, in view of the completion record 138 and when the host system 102 is to use a portion 158 (e.g., a sub block) of the data 151 in computation, the host system 102 can execute a load instruction 173 to retrieve the portion 158 of the data 151 from a memory address 128 in the memory space 121. For example, the execution of the load instruction in the host system 102 can cause the memory controller 116 in the host system 102 to load the data portion 158 from the memory address 128 in the memory space 121 of the memory sub-system 101 into the host system 102 using a memory access protocol without loading the remaining portion(s) (e.g., 157) of the data 151.

Thus, the host system 102 can control which portion of the data 151 at the logical block address 134 is to be communicated from the memory sub-system 101 at a time close to when the portion is to be used in computations performed in the host system 102.

Optionally, when the host system 102 is to use the entire block of data 151 at the logical block address 134, the host system 102 can configure the read command 171 to have a memory address 124 that is in the host memory 145, such that the execution of the read command 171 in the memory sub-system 101 can result in the memory sub-system 101 delivering the block of data 151 to the host memory 145. Thus, the host system 102 has the options to configure the read command 171 to have a memory address 124 in the memory space 121 of the memory sub-system 101 or a memory address in the host memory 145 and thus outside of the memory sub-system 101. The host system 102 can select an option from the available options based on how the data 151 is to be used in the computations performed in the host system 102 for optimal performance of the computing system 100 as a whole.

Optionally, the memory space 121 is partitioned into a plurality of memory blocks, each having a size for holding the entire block of data (e.g., 151) stored at one logical block address (e.g., 134) in the storage space 131. The memory address 124 specified in the read command 171 can be used to identify which block of the plurality of predefined/pre-partitioned memory blocks in the memory space 121 is to be used to hold the data (e.g., 151) retrieved from the logical block address (e.g., 134) identified in a read command (e.g., 171). When the memory address 124 specified in the read command 171 does not align with any of the block boundaries of the memory blocks in the memory space 121, the misalignment can be detected as an indication that the beginning portion of the memory block, up to (but not including) the memory address 124, is not to be modified. Thus, the execution of such a read command (e.g., 171) in the memory sub-system 101 can include the memory sub-system 101 retrieving the entire block of data 151 at the logical block address 134, identifying the beginning portion of the data 151 having a size that is equal to the capacity of the beginning portion of the memory block that is not be modified, discarding the beginning portion of the data 151, and storing the remaining portion of the data 151 starting from the memory address 124 identified in the read command (e.g., 171).

Optionally, the read command 171 can include a count of consecutive memory addresses, starting from the memory address 124 specified in the read command 171, as the destination to store at least a portion of the data 151 retrieved from the logical block address 134 in the storage space 131. The block of consecutive memory addresses identified via the read command 171 is configured in one of the plurality of predefined/pre-partitioned memory blocks in the memory space 121. The beginning and/or the end of the consecutive memory addresses identified via the read command 171 can have a misalignment(s) with the beginning and/or the end of the predefined/pre-partitioned memory block that contains the consecutive memory addresses. The misalignment(s) can be detected as an indication that the content at the memory addresses in the predefined/pre-partitioned memory block but outside of the consecutive memory addresses identified via the read command 171 is not to be modified.

For example, when the beginning memory address of the consecutive memory addresses (e.g., the smallest memory address among the consecutive memory addresses) is not the same as the beginning memory address of the memory block (e.g., the smallest memory address in the memory block containing the consecutive memory addresses), the misalignment can cause the memory sub-system 101 to skip storing a beginning portion of the user data 151 into the memory block, where the beginning portion of the user data 151 has the size corresponding to the difference between the beginning memory address of the consecutive memory addresses and the beginning memory address of the memory block.

Similarly, when the ending memory address of the consecutive memory addresses (e.g., the largest memory address among the consecutive memory addresses) is not the same as the ending memory address of the memory block (e.g., the largest memory address in the memory block containing the consecutive memory addresses), the misalignment can cause the memory sub-system 101 to skip storing an ending portion of the user data 151 into the memory block, where the ending portion of the user data 151 has the size corresponding to the difference between the ending memory address of the consecutive memory addresses and the ending memory address of the memory block.

Thus, the consecutive memory addresses can be specified by the host system 102 to cause the memory sub-system 101 to store the user data 151 into one of a plurality of predefined/partitioned memory blocks which contains the consecutive memory addresses but only in the consecutive memory addresses by discarding the portion(s) that would be stored in the block but outside of the consecutive memory addresses.

Optionally, the read command 171 can include a field configured to identify the ending memory address of the consecutive memory addresses, in additional to a field configured to identify the beginning memory address (e.g., 124) of the consecutive memory addresses. The memory addresses specified in the fields of the read command 171 identify the consecutive memory addresses selected by the host system 102 to store at least a portion of the user data 151 retrieved from the logical block address 134, where the portion is selected in relation with predefined boundaries of memory blocks in the memory space 121.

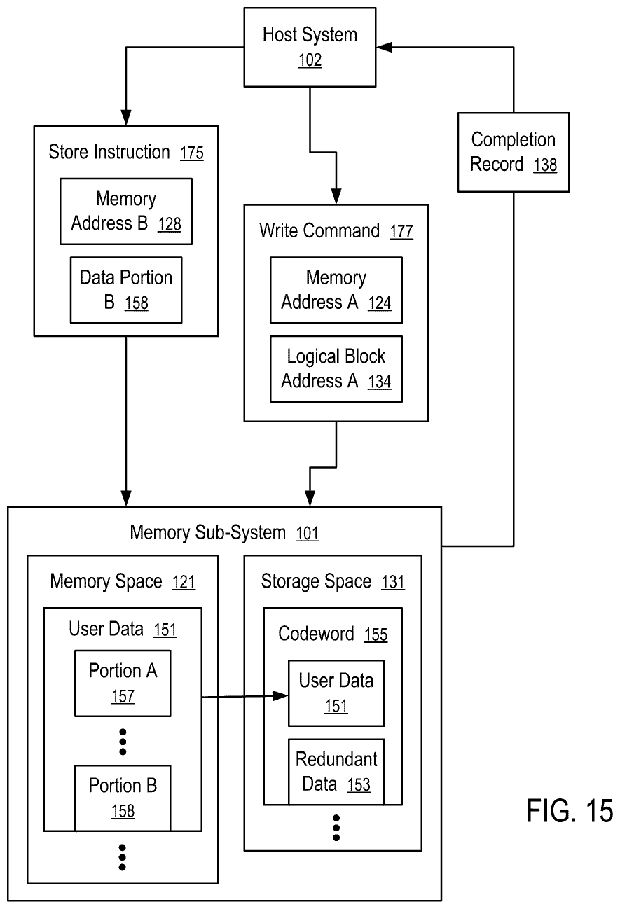

FIG. 15 shows communications to store data from a host system to a logical block address in a memory sub-system according to one embodiment. For example, communications can be implemented in a computing system 100 of FIG. 1 having a memory sub-system 101 according to FIG. 2 to FIG. 8 connected according to FIG. 9 to FIG. 13.

In FIG. 15, the host system 102 is configured to use a memory space 121 in the memory sub-system 101 as a staging ground to build up a block of data 151 to be written to a logical block address 134 in the storage space 131 of the memory sub-system 101.

For example, the host system 102 can use optionally use a read command 171 as in FIG. 14 to retrieve a block of data 151 from the logical block address 134 into the memory space 121 for modification.

For example, the host system 102 can use a store instruction 175 to store a data portion 158 to a memory address 128 in the memory space 121 to modify a corresponding portion (e.g., a sub block) of the block of data 151 previously retrieved via the read command 171 (e.g., as in FIG. 14), and/or to build up the block of data 151 one portion at a time via execution of a plurality of store instructions (e.g., 175). For example, the execution of a store instruction in the host system 102 can cause the memory controller 116 in the host system 102 to store the data portion 158 (e.g., in accordance with a memory access protocol) to the memory address 128 in the memory space 121 of the memory sub-system 101 without communicating the remaining portion (e.g., 157) of the data 151 to the memory sub-system 101.

After the data to be written to the storage space 131 is stored to the memory space 121 via one or more store instructions (e.g., 175), the host system 102 can send to the memory sub-system 101 a write command 177 that specifies a memory address 128 to indicate the source location of the data 151 for writing the data 151 to the storage space 131.

Since the data size 135 of the user data 151 at the logical block address 134 is a multiple of the data size 125 at each memory address (e.g., 124, . . . , 128) in the memory space 121, the user data 151 occupies a plurality of memory addresses (e.g., 124, . . . , 128) in the memory space 121. Thus, the host system 102 can build up the user data 151 in the memory space 121 one portion (e.g., 157, or 158) at a time.

The host system 102 can send the write command 177 to the memory sub-system 101 using a storage access protocol (e.g., in accordance with an NVMe standard). For example, the host system 102 can enter the write command 177 as a storage access request 137 in a submission queue 141 for retrieval by the memory sub-system 101 (e.g., in accordance with an NVMe standard). For example, the submission queue 141 can be configured in the memory space 121 of the memory sub-system 101 (e.g., as in FIG. 5 or FIG. 7), or in the host memory 145 (e.g., as in FIG. 6). For example, the submission queue 141 can be configured in a memory device (e.g., 167 or 168) connected to a portion of a CXL fabric 169 as in FIG. 13.

The execution of the write command 177 in the memory sub-system 101 causes the memory sub-system 101 to generate a codeword 155 from encoding the user data 151 in the memory space 121 (e.g., encoded using an error correction code technique to include the redundant data 153), and program a memory page in the storage space 131 to store the codeword 155.

After the execution of the write command 177 in the memory sub-system 101, the memory sub-system 101 can send a completion record 138 to the host system 102 (e.g., in accordance with an NVMe standard) to indicate the persistent storage of the user data 151 in the storage space 131. Thus, the data 151 in the memory space 121 can be discarded.

For example, the host system 102 can enter the completion record 138 in a completion queue 143 for retrieval by the host system 102. For example, the completion queue 143 can be configured in the memory space 121 of the memory sub-system 101 (e.g., as in FIG. 5), or in the host memory 145 (e.g., as in FIG. 6 or FIG. 7). For example, the completion queue 143 can be configured in a memory device (e.g., 167 or 168) connected to a portion of a CXL fabric 169 as in FIG. 13.

In some implementations, the memory address 124 is configured to represent the beginning memory address of a plurality of consecutive memory addresses 124, . . . , 128 used to provide at least a portion of a block of data 151 to be written to the logical block address 134.

Optionally, when the host system 102 has the entire block of data 151 to be written to the logical block address 134, the host system 102 can configure the write command 177 to have a memory address 124 that is in the host memory 145, such that the execution of the write command 177 in the memory sub-system 101 can result in the memory sub-system 101 retrieving the block of data 151 from the host memory 145. Thus, the host system 102 has the options to configure the write command 177 to have a memory address 124 in the memory space 121 of the memory sub-system 101 or a memory address in the host memory 145 and thus outside of the memory sub-system 101. The host system 102 can select an option from the available options based on how the data 151 is to be generated in the computations performed in the host system 102 for optimal performance of the computing system 100 as a whole.

Optionally, the memory space 121 is partitioned into a plurality of memory blocks, each having a size for holding the entire block of data (e.g., 151) stored at one logical block address (e.g., 134) in the storage space 131. The memory address 124 specified in the write command 177 can be used to identify which block of the plurality of predefined/pre-partitioned memory blocks in the memory space 121 is selected to provide at least a portion of the block of data 151 to be written into the logical block address 134 identified in the write command 177. When the memory address 124 specified in the write command 177 does not align with any of the block boundaries of the memory blocks in the memory space 121, the misalignment can be detected as an indication that the beginning portion of the predefined/pre-partitioned memory block, up to (but not including) the memory address 124, does not contain a corresponding portion of the block of the data 151 to be written to the logical block address 134. Thus, the execution of such a write command (e.g., 177) in the memory sub-system 101 can include the memory sub-system 101 determining the corresponding portion of the block of the data 151 that is not in the memory block identified via the memory address 124. For example, the memory sub-system 101 can determine the corresponding portion, not provided by the host system 102 for the write command 177, via reading the current codeword stored at the logical block address 134, and extracting the corresponding portion based on a difference between the memory address 124 and the beginning of the predefined/pre-partitioned memory block that contains the memory address 124. Alternatively, the corresponding portion of the block of the data 151 that is not in the memory block identified via the memory address 124 can be determined based on filling in the portion with a predetermined value (e.g., zero).

Optionally, the write command 177 can include a count of consecutive memory addresses, starting from the memory address 124 specified in the write command 177, as the source location of at least a portion of the data 151 to be written to the logical block address 134 in the storage space 131. The block of consecutive memory addresses identified via the write command 177 is configured in one of the plurality of predefined/pre-partitioned memory blocks in the memory space 121. The beginning and/or the end of the consecutive memory addresses identified via the write command 177 can have a misalignment(s) with the beginning and/or the end of the predefined/pre-partitioned memory block that contains the consecutive memory addresses. The misalignment(s) can be detected as an indication that the content at the memory addresses in the predefined/pre-partitioned memory block but outside of the consecutive memory addresses identified via the write command 177 does not contain a corresponding portion(s) of the data 151 to be written to the logical block address 134.

For example, when the beginning memory address of the consecutive memory addresses (e.g., the smallest memory address among the consecutive memory addresses) is not the same as the beginning memory address of the memory block (e.g., the smallest memory address in the memory block containing the consecutive memory addresses), the misalignment can cause the memory sub-system 101 to determine a beginning portion of the user data 151 (e.g., via reading the logical block address 134 in the storage space 131 or filling in using a predetermined value), where the beginning portion of the user data 151 has the size corresponding to the difference between the beginning memory address of the consecutive memory addresses and the beginning memory address of the memory block.

Similarly, when the ending memory address of the consecutive memory addresses (e.g., the largest memory address among the consecutive memory addresses) is not the same as the ending memory address of the memory block (e.g., the largest memory address in the memory block containing the consecutive memory addresses), the misalignment can cause the memory sub-system 101 to determine an ending portion of the user data 151 (e.g., via reading the logical block address 134 in the storage space 131 or filling in using a predetermined value), where the ending portion of the user data 151 has the size corresponding to the difference between the ending memory address of the consecutive memory addresses and the ending memory address of the memory block.

Thus, the consecutive memory addresses can be specified by the host system 102 to cause the memory sub-system 101 to determine one or more missing portions of the user data 151 (e.g., via reading the logical block address 134 in the storage space 131 or filling in using a predetermined value) and construct the entire block of data 151 from the missing portions and a portion of the user data 151 provided in the consecutive memory addresses.

Optionally, the write command 177 can include a field configured to identify the ending memory address of the consecutive memory addresses, in additional to a field configured to identify the beginning memory address (e.g., 124) of the consecutive memory addresses. The memory addresses specified in the fields of the write command 177 identify the consecutive memory addresses selected by the host system 102 to provide at least a portion of the user data 151 for writing the entire block of the data 151 to the logical block address 134 in the storage space of the memory sub-system 101. When the host system 102 uses the consecutive memory addresses in the memory space 121 to provide only a portion of the user data 151 to be written into the logical block address 134 in the storage space 131, the memory sub-system 101 can automatically determines the remaining portion of the user data 151 (e.g., by reading the current data at the logical block address 134 or filing in with a predetermined number) such that no further communications between the host system 102 and the memory sub-system 101 is necessary for specifying the data in the remaining portion of the user data 151. Alternatively, the host system 102 can use a read command 171 as in FIG. 14 to pre-load the current data at the logical block address 134 into the memory block for modification via the execution of a store instruction(s) (e.g., 175).

In at least some embodiments, the memory sub-system 101 is configured to manage the allocation, from the memory space 121 in the memory sub-system 101, of memory for use by applications running in the host system 102. For example, the memory sub-system 101 can control how memory in the memory space 121 is allocated to applications running in the host system 102.

For example, before an application running in the host system 102 reads data from the storage space 131 of the memory sub-system 101, the application can request the operating system in the host system 102 to dynamically allocate a chunk of memory. Subsequently, the host system 102 can configure a read command (e.g., 171) with a memory address in the allocated chunk of memory to cause the memory sub-system 101 to read data from the storage space 131 into the allocated chunk of memory for further processing by the application.

Instead of the operating system in the host system 102 allocating the chunk of memory according to its memory map 181, the host system 102 can forward the memory allocation request (e.g., in response to a malloc or mmap call) to the memory sub-system 101 of one embodiment. The memory sub-system 101 can be configured to manage the allocation of memory from its memory space 121.

For example, a communication standard (e.g., NVMe) for accessing the storage space 131 of the memory sub-system 101 can be extended to implement a command to allocate (or a request for the allocation of) a chunk of memory from the memory space 121 of the memory sub-system 101. The access manager 113 in the memory sub-system 101 can track which chunks of memory in the memory space 121 are free for allocation and which chunks of memory have been allocated and thus are currently in use. The memory allocation command (or request) can specify the size of the memory chunk to be allocated from the memory space 121 of the memory sub-system 101. The host system 102 can enter the memory allocation command or request in a submission queue (e.g., 141) configured for the memory sub-system 101. During the execution of the memory allocation command or request, the memory sub-system 101 can identify a chunk of free memory in the memory space 121 and allocate the chunk in response to the memory allocation command or request. After the execution of the command, the memory sub-system 101 can provide a completion record in a completion queue (e.g., 143) to identify the starting memory address (e.g., 124) of the allocated chunk of memory.

Subsequently, the host system 102 can configure a read command (e.g., 171 and according to an NVMe standard) to identify the allocated chunk of memory as the destination of the read operation of the read command. During the execution of the read command (e.g., 171), the memory sub-system reads data identified by a logical block address (e.g., 134, such as an LBA address according to an NVMe standard) in the storage space 131 and stores the data into the memory chunk according to the starting memory address (e.g., 124) identified by the host system 102 in the read command (e.g., 171) (e.g., as discussed above in connection with FIG. 2 to FIG. 14). Since the starting memory address (e.g., 124) is provided by the memory sub-system 101 in the completion record to identify the chunk of memory allocated in response to the memory allocation command/request, the execution of the read command results in the data being read into the chunk of memory allocated according to the memory allocation command/request.

Optionally, the read command (e.g., 171) can request the retrieval of the data from a contiguous segment of logical block addresses. For example, the segment can be specified in the read command (e.g., 171) via the starting logical block address (e.g., 134) and a size of the segment (or an ending logical block address). When the memory address (e.g., 124) is specified in such a read command (e.g., 171), the data retrieved via the execution of such the read command (e.g., 171) can be stored in the memory space 121 at the destination location identified via a memory address (e.g., 124) of the allocated chunk of memory.

Optionally, the application can use the allocated chunk of memory in a read-modify-write operation. For example, the application can modify one or more portions of the data retrieved via the read command into the chunk of memory allocated from the memory space 121 of the memory sub-system 101. After the modification using a memory access protocol, the host system 102 can issue a write command (e.g., 177 and according to an NVMe standard) to write the data from the allocated chunk of memory in the memory sub-system 101 to the storage space 131 of the memory sub-system 101 (e.g., as discussed above in connection with FIG. 15).

Optionally, the application can use the allocated chunk of memory in tasks unrelated to reading data from and/or writing data to the storage space 131 of the memory sub-system 101.

When the application frees the allocated chunk of memory (e.g., via a free call), the host system 102 can forward the request to the memory sub-system 101. For example, the host system 102 can enter a memory return command/request in the submission queue (e.g., 141) configured for the memory sub-system 101. For example, the memory return command/request entered in the submission queue (e.g., 141) can identify the starting memory address (e.g., 124) of the memory chunk to be freed, such as the memory address previously identified by the memory sub-system 101 in a completion record for the execution of a memory allocation command/request. Alternatively, or in combination, the memory return command/request entered in the submission queue (e.g., 141) to free a chunk of memory can identify an identification of the memory allocation command/request previously used to allocate the chunk of memory; and the memory sub-system 101 can determine the chunk of memory to be freed based at least in part on the identification of the memory allocation command/request that causes the chunk of memory to be allocated.

Optionally, the memory sub-system 101 can impose no predetermined relation between the data in the allocated chunk of memory in the memory space 121, and the data stored at any logical block addresses in the storage space 131. For example, the host system 102 can optionally request the memory sub-system 101 to execute a read command 171 to retrieve the data from a logical block address into the allocated chunk of memory to cause the data in the allocated chunk of memory to be the same as the data at the logical block address. Subsequently, the host system 102 can optionally modify the data in the allocated chunk of memory to cause the data in the allocated chunk of memory to be different from the data at the logical block address. Optionally, the host system 102 can discard the modified content in the allocated chunk of memory (e.g., by freeing the chunk of memory without writing the content in the chunk of memory to the storage space 131). Alternatively, the host system 102 can request the memory sub-system 101 to execute a write command 177 to write the modified data in the allocated chunk of memory to the storage space 131 (e.g., at the same logical block address or another logical block address) so that the allocated chunk of memory again stores the same data as the respective logical block address identified in the write command 177.

Optionally, the memory sub-system 101 is configured to track the data that is both at a logical block address (e.g., 134) in the storage space 131 and at a memory address (e.g., 124) in the memory space 121.

Optionally, when the same data is stored both at a logical block address (e.g., 134) in the storage space 131 and at a memory address (e.g., 124) in the memory space 121, the memory sub-system 101 can update the metadata 130 to indicate that the storage medium of the logical block address (e.g., 134) is currently in the memory space 121 at the memory address (e.g., 124) and that the memory page 133 storing the same data can be optionally erased.

Optionally, the allocated memory chunk storing data for a logical block address (e.g., 134) in the storage space 131 (e.g., as a result of execution of a read command 171 or a write command 177) can be used as a cache/buffer memory allocated for the logical block address (e.g., 134). The memory sub-system 101 can be optionally configured to write the content from the allocated memory chunk to the logical block address (e.g., 134) upon freeing or reallocating the memory chunk, if the cached content in the allocated memory chunk has been modified (e.g., via memory access requests 127).

Optionally, a read command to access the storage space 131 of the memory sub-system 101 can be configured to include a request to allocate a chunk of memory, from the memory space 121 of the memory sub-system 101. During the execution of the read command, the memory sub-system 101 allocates a chunk of memory according to the size of the data being read from the storage space 131, and loads data read from the storage space 131 into the allocated chunk of memory. In a completion record for the read command, the memory sub-system 101 can identify the starting memory address of the allocated chunk of memory such that the host system 102 can use a memory access protocol to use selected portions of the data in the allocated chunk of memory.

A conventional read command (e.g., according to NVMe) is configured to specify a memory location as the destination for the read operation. During execution of the read command, a memory sub-system (e.g., solid-state drive (SSD)) is to send the data to the memory location identified via the memory address specified in the read command. Before using such a conventional read command, a host system is to perform operations to allocate a chunk of memory and then configure the read command to specify a memory address of the memory chunk as the read destination.

Optionally, such a read command can be extended to include a built-in memory allocation request. When such a read command with a built-in memory allocation request is used, the host system 102 can skip the operations and/or communications to allocate the chunk of memory before configuring the read command with a memory address of the allocated chunk of memory. As a result, the performance of the computing system 100 can be improved.

For example, a read command with a built-in memory allocation request can be configured to be functionally equivalent to entering, in a submission queue, a memory allocation request for a chunk of memory and, after obtaining the address of the allocated chunk of memory, configuring a read command to include the address of the allocated chunk of memory as the read destination, and entering the read command in the submission queue for execution by the memory sub-system. When a read command is configured with a built-in memory allocation request, the latency of the round trip communications to obtain the memory address of the allocated chunk of memory can be eliminated; and the efficiency of the usage of the communication channel between the host system and the memory sub-system can be improved.

For example, a memory allocation request can be built into a read command in the form of the lack of a valid memory location specified as the destination of the read operation. When the memory sub-system 101 detects that the memory address specified in the read command as the read destination is invalid for the memory sub-system 101 and/or the host system 102 to access over the connection 107, the memory sub-system 101 can automatically allocate a chunk of memory from the memory space 121 of the memory sub-system 101 during execution of the read command and store the data retrieved via the execution of the read command to the allocated chunk of memory. In a completion record provided for the read command, the memory sub-system 101 can identify the starting memory address of the chunk of memory storing the data retrieved via the execution of the read command. As a result, the host system 102 can skip sending a separate memory allocation request to allocate a memory block to hold the data retrieved via the execution of the read command.

Optionally and/or in combination, a predetermined memory address can be used in a read command as a request for allocation of memory to hold the data retrieved via the execution of the read command. For example, the predetermined memory address (e.g., zero) can be in a range of memory addresses that are predefined as invalid for the memory sub-system 101 to store data retrieved via execution of read commands. For example, a memory address in the segment of memory in the memory space 121 of the memory sub-system 101 to host a submission queue 141 (or a completion queue 143) can be specified as a read destination of a read command to represent a memory allocation request built in the read command.

Optionally and/or in combination, a predetermined opcode can be used in the read command to identify the memory allocation request in connection with a read operation. Optionally and/or in combination, a parameter in the read command is configured to represent a request for memory allocation to be performed during the execution of the read command.

In general, the read command specifies the size of the data to be read. When the read command has a built-in memory allocation request, the memory sub-system can use the size of the data to be read as the size of the chunk of memory to be allocated. Thus, it is not necessary to separately specify the size of the memory chunk to be allocated in the read command.

Alternatively, a field in the read command can be configured to specify the size of the memory chunk to be allocated via the execution of the read command; and the size of the memory chunk being allocated can be different from the size of the data to be read via the execution of the read command. For example, when the size of the memory chunk being allocated is smaller than the size of the data being read from the storage space 131 via the execution of the read command, the data retrieved from the storage space 131 can be truncated when being loaded into the allocated chunk of memory. For example, when the size of the memory chunk being allocated is larger than the size of the data being read from the storage space 131 via the execution of the read command, the host system 102 can use the additional memory space in the allocated chunk of memory to store data related to the processing of the data read from the storage space 131 and/or other data.

Optionally, the host system 102 can send an access completion notification to the memory sub-system 101 to indicate that the input output access associated with the execution of a storage access request (e.g., a read command or a write command) is complete such that the memory sub-system 101 can release the resources previously allocated and/or used for the storage access request. Such resources can include memory chunks allocated from the memory space 121. For example, the access completion notification can be entered in a submission queue (e.g., 141) to cause the memory sub-system 101 to free a chunk of memory previously allocated from the memory space 121 of the memory sub-system 101 and used during the execution of a read or write command in the memory sub-system 101.

For example, the access manager 113 in the memory sub-system 101 can track the memory chunks that have been allocated from the memory space 121 of the memory sub-system and that have been used in execution of storage access requests (e.g., read commands, write commands). When the host system 102 sends an access completion notification that identifies one or more such storage access requests (e.g., via command identifications of the storage access requests), the memory sub-system 101 can deallocate the memory chunks that have been used during the execution of the storage access requests identified via the access completion notification.

For example, the host system 102 can allocate a chuck of memory via entering, in a submission queue of the memory sub-system, a memory allocation request or a read command having a built-in memory allocation request. After the execution of a read command in the memory sub-system 101 to retrieve data into the allocated chunk of memory, the host system 102 can use and/or modify the data in the chunk of memory using a memory access protocol. When the host system 102 sends an access completion notification identifying the read command, the memory sub-system 101 can identify the chunk of memory used during the execution of the read command and thus return/free the chunk of memory.

In some implementations, a write command can include a built-in memory return request. For example, when a write command is executed to write data from the memory space 121 in the memory sub-system 101 to the storage space 131 in the memory sub-system 101, the memory sub-system 101 can return/free the chunk of memory.

For example, a built-in memory return request can be specified in a write command in the form of a memory address of the chunk of memory allocated from the memory space 121 as the source location of the data to be written to the storage space 131. In response to a determination that the memory address is in a chunk of memory allocated from the memory space 121 and/or allocated via a read command executed in the memory sub-system 101, the memory sub-system 101 can free the chunk of memory upon completion of the execution of the write operation for the write command.

Alternatively, and/or in combination, a memory return request can be specified in a write command in the form of an opcode or another indicator specified in a predefined field in the write command.

Optionally, the memory sub-system 101 can track of a list of memory chunks that are storing the same data as certain logical block addresses in the storage space 131. When the host system 102 sends a storage access request to read the data from such a logical block address, the memory sub-system 101 can use a respective memory chunk to complete the execution of the request without reading the storage space 131 according to the logical block address.

For example, after the execution of a read command configured to retrieve data from a logical block address to a memory address in the memory space 121, the memory sub-system 101 can update the list to indicate that the memory address stores the same data as the logical block address. When the host system 102 modifies the data in the memory space 121, the memory sub-system 101 can update the list to indicate that the memory address no longer stores the same data as the logical block address. After the execution of a write command to write the modified data from the memory address to a logical block address, the memory sub-system 101 can further update the list to indicate that the memory address stores the same data as the logical block address. When the memory chunk is freed and/or reallocated (e.g., in response to a read command or a memory allocation request), the memory sub-system 101 can erase the memory chunk and remove it from the list of memory chunks that are storing the same data as logical block addresses.

Optionally, a memory chunk can be allocated with a caching/buffering option such that the content of the memory chunk is considered the current content at a respective logical block address. In response to a request to reallocate and/or free the memory chunk, the memory sub-system 101 is configured to automatically commit the content of the memory chunk to the logical block address in the storage space 131, if the content has been modified after being read into the memory chunk from the logical block address. Thus, it is not necessary for the host system 102 to send a separate write command for the storing of the modified content from the memory chunk to the storage space 131 of the memory sub-system 101.

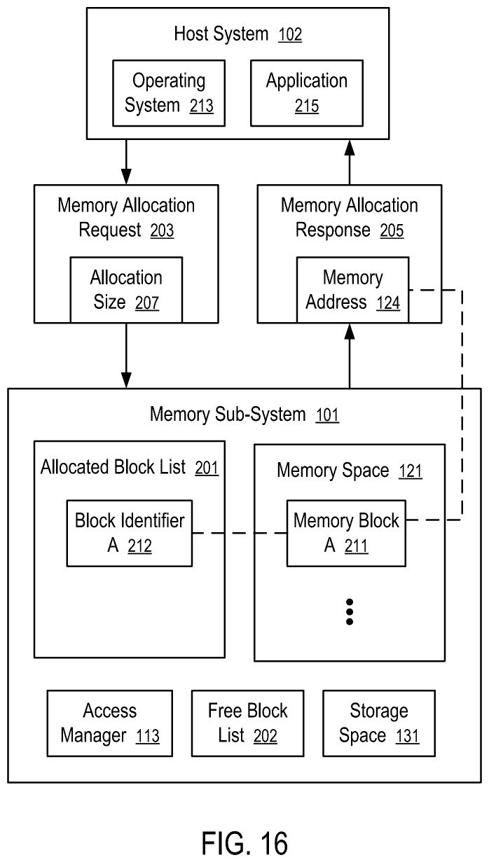

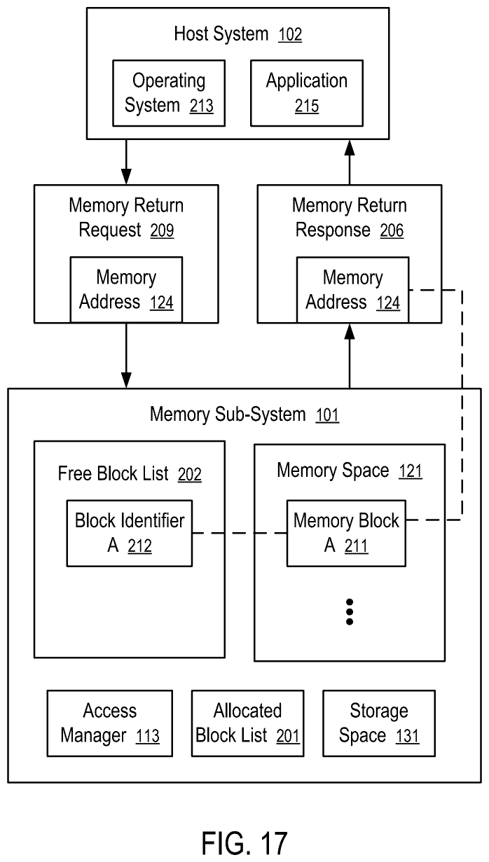

FIG. 16 and FIG. 17 show management of memory in a memory space of a memory sub-system according to one embodiment.

For example, an access manager 113 in the memory sub-system 101 in FIG. 16 and FIG. 17 can be configured to manage the allocation and freeing of memory chunks from the memory space 121.

For example, when an application 215 running in the host system 102 is to use a chunk of memory in the memory space 121 in the memory sub-system 101, the host system 102 can send a memory allocation request 203 to the memory sub-system 101.

For example, the memory allocation request 203 can be entered in a submission queue 141 configured for the memory sub-system 101. The submission queue 141 can be configured in the memory space 121 of the memory sub-system 101 (e.g., as in FIG. 5 and FIG. 7), or as in the host memory 145 (e.g., as in FIG. 6).

The memory allocation request 203 can include a field configured to identify the size 207 of a chunk of memory to be allocated from the memory space 121.

The access manager 113 in the memory sub-system 101 can track a list 202 of memory chunks/blocks that are free to be allocated for use by the host system 102, and a list 201 of memory chunks/block that have been allocated for use (e.g., by the host system 102 and/or by the memory sub-system 101).

In some implementations, memory blocks not in the free block list 202 are considered to have been allocated and thus in use. In other implementations, memory blocks not in the allocated block list 201 are considered free for allocation. Thus, the memory sub-system 101 can optionally maintain one of the two lists 201 and 202 without the other.

In response to the memory allocation request 203, the access manager 113 in the memory sub-system 101 can identify a free memory block 211 in the memory space 121 according to the free block list 202. The access manager 113 can move the block identifier 212 of the memory block 211 from the free block list 202 to the allocated block list 201 to indicate that the memory block 211 has been allocated for use and thus no longer free for allocation. The memory sub-system 101 can send a memory allocation response 205 to the host system 102 as a response to the memory allocation request 203. The memory allocation response 205 can include the starting memory address 124 of the memory block 211.

For example, the block identifier 212 can include the starting memory address 124 of the memory block 211 and the size 207 of the allocated memory block 211.

For example, the memory sub-system 101 can provide the memory allocation response 205 to the host system 102 via a completion record for the execution of the memory allocation request 203 retrieved from a submission queue 141. The completion record can be entered in a completion queue 143 for processing by the host system 102. The completion queue 143 can be configured in the host memory 145 (e.g., as in FIG. 6 and FIG. 7), or in the memory space 121 of the memory sub-system 101 (e.g., as in FIG. 5).

Optionally, the application 215 can use the allocated memory block 211 to buffer data retrieved from the storage space 131. For example, the host system 102 can specify the memory address 124 of the allocated memory block 211 in a read command 171 to read user data 151 from the storage space 131 into the allocated memory block 211 (e.g., as in FIG. 14).

For example, the host system 102 can build up user data 151 in the allocated memory block 211 one portion (e.g., 157 or 158) at a time and then specify the memory address 124 of the allocated memory block 211 as a data source location in a write command 177 to write the user data 151 from the allocated memory block 211 to the storage space 131 (e.g., as in FIG. 15).

Optionally, the memory sub-system 101 can erase the memory block 211 before sending the memory allocation response 205 to the host system 102.

When the application 215 completes its usage of the allocated memory block 211, the host system 102 can send a memory return request 209 as in FIG. 17 to the memory sub-system 101 to free the memory block 211 such that the memory block 211 can be reallocated for use by the memory sub-system 101 or by the host system 102 (e.g., for use by the application 215, or another application or the operating system 213 running in the host system 102).

For example, the memory return request 209 can be entered in a submission queue 141 configured for the memory sub-system 101. The submission queue 141 can be configured in the memory space 121 of the memory sub-system 101 (e.g., as in FIG. 5 and FIG. 7), or as in the host memory 145 (e.g., as in FIG. 6).

The memory return request 209 can include a field configured to identify the starting memory address 124 of the chunk of memory to be freed. Alternatively, or in combination, the memory return request 209 can include a field configured to identify the memory allocation request 203 (e.g., using a command ID of the memory allocation request 203) that causes the memory block 211 to be allocated; and the memory sub-system 101 can determine the identifier 212 of the memory block 211 to be freed from the command ID of the memory allocation request 203.

In response to the memory return request 209, the access manager 113 in the memory sub-system 101 can identify the memory block 211 to be freed (e.g., based on the starting memory address 124 of the memory block 211 and/or the command ID of the memory allocation request 203 that causes the memory block 211 to be allocated). The access manager 113 can move the block identifier 212 of the memory block 211 from the allocated block list 201 to the free block list 202 to indicate that the memory block 211 is now free for allocation. The memory sub-system 101 can send a memory return response 206 to the host system 102 as a response to the memory return request 209. Optionally, the memory return response 206 can include the starting memory address 124 of the memory block 211 being freed.

For example, the memory sub-system 101 can provide the memory return 206 to the host system 102 via a completion record for the execution of the memory return request 209 retrieved from a submission queue 141. The completion record can be entered in a completion queue 143 for retrieval and processing by the host system 102. The completion queue 143 can be configured in the host memory 145 (e.g., as in FIG. 6 and FIG. 7), or in the memory space 121 of the memory sub-system 101 (e.g., as in FIG. 5).

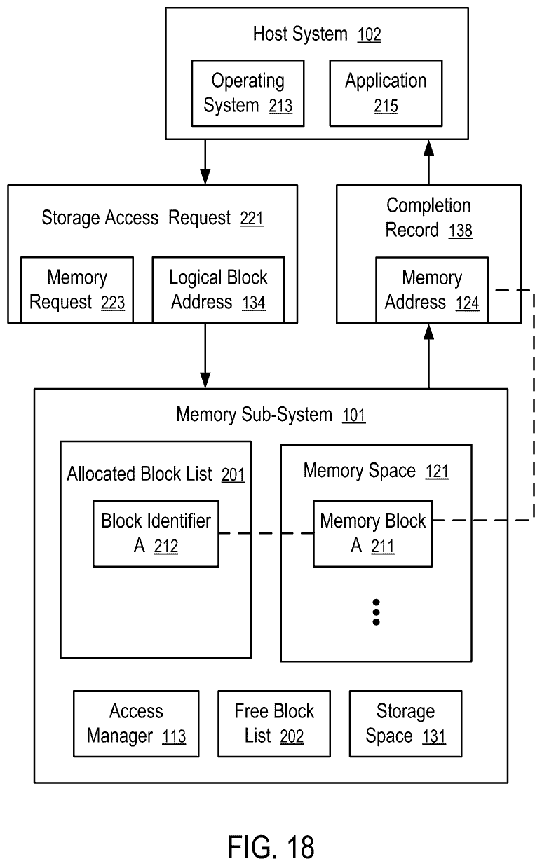

FIG. 18 shows integrating memory allocation requests in storage access requests according to some embodiments.

In FIG. 18, a storage access request 221 is configured to access a logical block address 134 and configured to include an embedded memory request 223. The execution of the storage access request 221 in the memory sub-system 101 can result in the allocation of a memory block 211, in addition to accessing at least the logical block address 134 in the storage space 131 (e.g., reading or writing at the logical block address 134 or a segment of contiguous logical block addresses starting with the logical block address 134).

For example, the memory request 223 can be specified via an opcode provided in the storage access request 221. For example, the opcode can be configured to request the allocation of a memory block in addition to a read or write operation according to the logical block address 134 in the storage space 131.

In some implementations, the size 207 of the memory block 211 to be allocated is specified in the storage access request 221 based on the data size of the storage access request 221, such as the size of data to be read from the storage space 131 (or written to the storage space 131) via the execution of the storage access request 221 in the memory sub-system 101.

Alternatively, or in combination, the storage access request 221 can be configured with a predefined field for specifying the allocation size 207 of the memory request 223.

For example, when the allocation size 207 specified in the field of the storage access request 221 is zero (or larger than a predetermined threshold), the memory sub-system 101 can execute the storage access request 221 for accessing at least the logical block address 134 without allocating a memory block. However, when the allocation size 207 specified in the field of the storage access request 221 is non-zero (and no larger than the predetermined threshold), the memory sub-system 101 can allocate, during the execution of the storage access request 221, a memory block 211 according to the allocation size 207 specified in the field of the storage access request 221.

For example, the predetermined threshold can be the capacity of the memory space 121, or a predetermined fraction of the capacity of the memory space 121. When the allocation size 207 specified in the field of the storage access request 221 is equal to (or larger than) the predetermined threshold, the memory sub-system 101 can execute the storage access request 221 without allocating a memory block 211.

For example, when the allocation size 207 specified in the field of the storage access request 221 is equal to zero (or another predetermined number), the memory sub-system 101 can allocate a memory block 211 according to the data size of the storage access request 221.

In some instances, the allocation size 207 specified in the field of the storage access request 221 is not configured to indicate the lack of a memory request (e.g., above zero and below the threshold); and the allocation size 207 can be different from the size of data to be read or written via the execution of the storage access request 221 in the memory sub-system 101. During the execution of the storage access request 221, the memory sub-system 101 can allocate a memory block 211 according to the allocation size 207 specified in the field of the storage access request 221.

Alternatively, or in combination, the memory request 223 can be specified in the storage access request 221 in the form of the lack of a valid memory address (e.g., 124) as a source location or a destination location for writing to or reading from the logical block address 134.

For example, the storage access request 221 can include an opcode configured to cause the memory sub-system 101 to at least read data from at least the logical block address 134. When an invalid memory address is specified in the storage access request 221 as the destination location of the read operation, the invalid memory address can be recognized by the memory sub-system 101 as the memory request 223 and thus can cause the memory sub-system 101 to allocate a memory block 211 to hold the data being read.

For example, a read command can be configured with a null memory address as the destination location for the reading of data from at least the logical block address 134. In response to the null memory address being specified as the read destination, the memory sub-system 101 can allocate a memory block 211 in the memory space 121 and store the data, read from the storage space 131 according to the logical block address 134, into the memory block 211 during the execution of the read command. The completion record 138 for the read command can provide the starting memory address 124 of the allocated memory block 211. Based on the starting memory address 124, the host system 102 can select a memory address (e.g., 128 in the memory block 211) to selectively load a portion of the data from the allocated memory block 211 and/or to store data to a portion of the memory block 211 (e.g., for subsequent writing to the storage space 131).

In some implementations, the null memory address is a predetermined memory address (e.g., zero, a memory address in a range of memory addresses of a submission queue 141 configured for the memory sub-system 101, or a memory address in a range of memory addresses of a completion queue 143 configured for the memory sub-system 101).

Optionally, after the data at a logical block address 134 is read into the memory block 211, the memory sub-system 101 can update the metadata 130 to indicate that the memory block 211 now stores the data for the logical block address 134.

Optionally, the block identifier 212 of the memory block 211 can be configured to identify not only the starting memory address 124 of the allocated memory block 211, but also the logical block address 134 for which the memory block 211 is allocated.

Optionally, the memory sub-system 101 can further store data configured to indicate whether the memory block 211 allocated for the access of the logical block address 134 is configured as a cache (or buffer) for the logical block address 134.

When the memory block 211 is allocated as a cache (or buffer) for the logical block address 134 (or a segment of contiguous logical block addresses starting with the logical block address 134), the memory sub-system 101 can further store data indicating whether the content in the memory block 211 has been modified by the host system 102. If the content has been modified by the host system 102 via a memory access protocol, the memory sub-system 101 can further update the metadata 130 to indicate that the memory page (e.g., 133) previously used to store the data at the logical block address 134 can now be erased. If the cached/buffered content in the memory block 211 has been modified by the host system 102, freeing the memory block 211 can cause the memory sub-system 101 to automatically write the data from the memory block 211 to the storage space 131 according to the logical block address 134. Thus, the host system 102 does not have to send a write command via a submission queue (e.g., 141) to instruct the memory sub-system 101 to write the modified data from the memory block 211 to the storage space 131.

Optionally, the block identifier 212 can be configured to further identify the allocation size 207 of the memory block 211, the command ID of the read command that causes the allocation of the memory block 211, the size of the segment of logical block addresses for which the memory block 211 is storing data, and/or an identification of the host system 102 and/or a processing device 118 for which the memory block 211 is allocated.

Optionally, the storage access request 221 can include a scatter gather list (SGL) configured to identify one or more memory segments as a destination location for a read operation or a source location for a write operation. One or more memory segments in the scatter gather list (SGL) can be specified with a memory request 223 to cause the memory sub-system 101 to allocate a memory block and mapped the one or more memory segments to the allocated memory block.

For example, when the storage access request 221 specifies an opcode for a read operation, the memory sub-system 101 can extract portions of the data being read into memory segments identified by the scatter gather list (SGL). When the scatter gather list (SGL) includes one or more memory segments having a memory request 223, the memory sub-system 101 can allocate the memory block 211, and map the one or more memory segments into the memory block 211 via concatenation. Thus, the data to be read into the one or more memory segments are stored in the allocated memory block 211. The host system 102 can perform the same address mapping to access the corresponding data in the memory block 211 as identified via the starting memory address 124 provided in the completion record 138.

For example, when the storage access request 221 specifies an opcode for a write operation, the memory sub-system 101 can perform a read-modify-write operation by modifying the data read according to the logical block address 134 in the storage space 131. The data read from the storage space 131 can be modified using data provided at memory segments specified in the scatter gather list (SGL). Optionally, the scatter gather list (SGL) can include one or more first memory segments having a memory request 223 and one or more second memory segments having no memory request. During the read phase, the memory sub-system 101 can allocate a memory block 211 and read data into the one or more first memory segments in a same ways as if the opcode were for a read operation. During the modification phase, the memory sub-system 101 can retrieve data from the one or more second memory segments to modify the data obtained from reading the storage space 131 according to the logical block address 134. During the write phase, the modified data as generated during the modification phase is written back to at least the logical block address 134. As a result, the storage access request 221 with the opcode for the write operation can be used a scatter gather list (SGL) to modify one or more portions of the content in the storage space 131 starting at the logical block address 134 and retrieve one or more other portions of the content into the allocated memory block 211 for further accessing by the host system 102 using a memory access protocol (e.g., as in FIG. 4).

Optionally, when the storage access request 221 specifies an opcode for a write operation, the memory sub-system 101 can perform a read-modify-write operation by modifying the data read according to the logical block address 134 in the storage space 131. The data read from the storage space 131 can be modified using data provided at memory segments specified in the scatter gather list (SGL). The modified data is written to the storage space 131 according to the logical block address. When the storage access request 221 includes a memory request, the memory sub-system 101 allocates a memory block 211 to hold the modified data being written to the storage space 131 and provides the starting memory address 124 of the memory block 211 in the completion record 138 to allow the host system 102 to selectively access the modified data using a memory access request (e.g., 127).

In some implementations, an indication of memory return can be integrated in a storage access request.

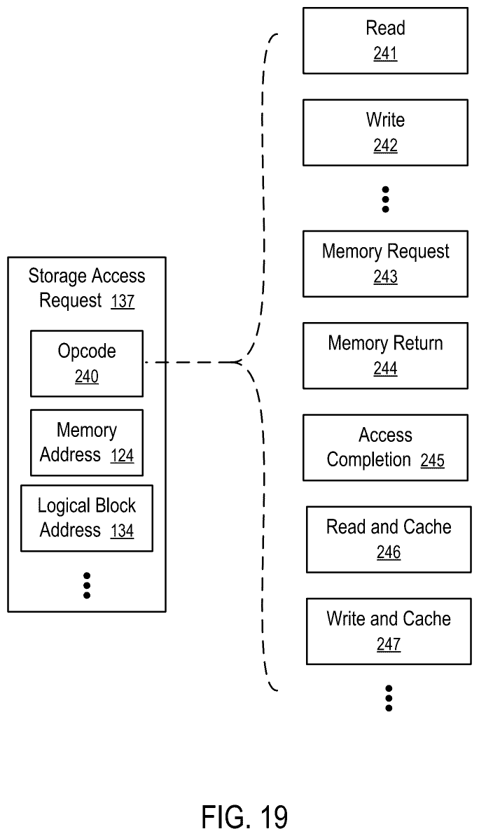

FIG. 19 shows examples of opcodes that can be used in a storage access request according to one embodiment. For example, the storage access requests 137 (e.g., read commands 171, write commands 177) can be implemented using opcodes illustrated in FIG. 19.

In FIG. 19, a storage access request 137 includes a plurality of predefined fields, including a field for an opcode 240, a field for a memory address 124, and a field for a logical block address 134. The tasks to be performed by a memory sub-system 101 (e.g., as in FIG. 1) during the execution of the storage access request 137 are dependent on the value of the opcode 240 specified in the storage access request 137.

For example, when the opcode 240 has a predefined value associated with an operation for read 241, the storage access request 137 causes the memory sub-system 101 to read data from at least the logical block address 134 in the storage space 131 of the memory sub-system 101 to a destination location identified by the memory address 124.

Optionally, a null memory address can be used in the field of memory address 124 to represent a memory request 223, when the opcode 240 has the predefined value associated with the operation for read 241.

Optionally, the memory address 124 can be in the memory space 121 of the memory sub-system 101 to avoid the communication of the data being read from the memory sub-system 101 to outside of the memory sub-system 101. Subsequently, the host system 102 (e.g., as in FIG. 1) can use a memory access request 127 (e.g., as in FIG. 4) to access a portion of the data that has been read into the memory space 121 via the execution of the storage access request 137 having the opcode 240 for read 241.

Alternatively, the memory address 124 can be a null memory address, which cause the memory sub-system 101 to allocate a memory block 211 from the memory space 121 of the memory sub-system 101 as the destination location, as if the memory address 124 were the starting memory address 124 of the allocated memory block 211 in the memory space 121 of the memory sub-system 101.

Alternatively, the memory address 124 can be in the host memory 145, causing the memory sub-system 101 to use a memory access protocol to communicate the data retrieved from at least the logical block address 134 to the host memory 145.

Optionally, the destination location identified by the memory address 124 is provided only for part of the data being read from at least the logical block address 134. For example, a scatter gather list (SGL) can be used to specify the portion(s) to be extracted from the data to be read from the storage space 131 according to the logical block address 134. Optionally, the SGL can be configured to indicate that the memory for the portion(s) is to be allocated from the memory space 121; and in response, the memory sub-system 101 can allocate a memory block 211 and map the portion(s) to the memory block 211 via concatenation.

Alternatively, the opcode 240 can have a predefined value associated with an operation for write 242. In response, the memory sub-system 101 executing the storage access request 137 can write data from a source location identified by the memory address 124 to at least the logical block address 134 in the memory sub-system 101. For example, the memory address 124 can be in the memory space 121 of the memory sub-system 101 or in the host memory 145.

Optionally, the source location identified by the memory address 124 provides only part of the data to be written to at least the logical block address 134. For example, a scatter gather list (SGL) can be used to specify the portion(s) of the data that is provided at the source location; and the memory sub-system 101 is configured to perform a read-modify-write operation by reading at least the logical block address 134 for the data currently stored in the storage space 131, modifying the current data using the portion(s) from the source location, and writing the modified data back to the storage space 131 according to the logical block address 134. Optionally, the scatter gather list (SGL) can be configured to request extraction of some of the segments of the current data to be read from the storage space 131 of the memory sub-system 101, as if the opcode 240 were for the operation of read 241; and the scatter gather list (SGL) can be further configured to cause the memory sub-system 101 to allocate a memory block 211 as the destination location for providing the extracted the segments. Optionally, the storage access request 137 can include a memory request 223 to cause the memory sub-system 101 to allocate a memory block 211 to provide the entire data being written back to the storage space 131 according to the logical block address 134 (or the portion of the data that has not been modified by the data provided at the source location identified by the scatter gather list (SGL)).

Alternatively, the opcode 240 can have a predefined value associated with an operation for memory request 243. For example, the memory address 124 and/or the logical block address 134 can be used to identify the size of the data that can be read via the opcode 240 for read 241; and thus, the storage access request 137 having the opcode 240 for memory request 243 can cause the memory sub-system 101 to allocate a memory block 211 having a size that is equal to the size of the data, without causing the memory sub-system 101 to perform the operation to read from or write to the logical block address 134. For example, the memory to be allocated can be a portion of the data at the logical block address 134 identified via a scatter gather list (SGL).

Alternatively, the opcode 240 can have a predefined value associated with an operation for memory return 244. For example, the memory address 124 can be used to identify the starting memory address 124 of a memory block 211 previously allocated via the execution of a storage access request; and the memory sub-system 101 can execute the storage access request 137 having the opcode 240 for memory return 244 to free the memory block 211 from allocation. For example, the logical block address 134 can be used to identify a segment of continuous logical block addresses, starting from the logical block address 134, for which memory blocks (e.g., 211) have been previously allocated for the read and/or write access of the logical block address segment; and in response, the memory sub-system 101 is to free such memory blocks (e.g., 211).

Alternatively, the opcode 240 can have a predefined value associated with an operation for access completion 245. For example, the storage access request 137 can identify memory addresses (e.g., 124) and/or logical block addresses (e.g., 134) to indicate that the host system 102 has completed its access to memory locations in the memory space 121 in the memory sub-system 101 and/or storage locations in the storage space 131 in the memory sub-system 101; as a result, the memory sub-system 101 can free resources allocated to provide access to the corresponding memory locations and/or storage locations, such as memory blocks (e.g., 211) allocated from the memory space 121 and used in the host system 102 accessing the memory sub-system 101.

Alternatively, the opcode 240 can have a predefined value associated with an operation for read and cache 246. In response, the memory sub-system 101 allocates a memory block 211 as the destination for the read operation and cache the data retrieved from at least the logical block address 134 in the allocated memory block 211. The starting memory address of the memory block 211 is identified in the completion record 138 for the storage access request 137. Optionally, the memory sub-system 101 can update the metadata 130 to indicate that the data of at least the logical block address 134 is now in the allocated memory block 211 such that, if the content in the allocated memory block 211 is modified, freeing the memory block 211 can cause the writing of the content back according to the logical block address 134.

Alternatively, the opcode 240 can have a predefined value associated with an operation for write and cache 247. In response, the memory sub-system 101 writes the data from the source location identified by the memory address 124 to the storage space 131 according to the logical block address 134. If the source location as identified by the memory address 124 is not in the memory space 121 in the memory sub-system 101, the memory sub-system 101 can allocate a memory block 211 to cache the data being written to at least the logical block address 134 and return the starting memory address of the allocated memory block in the completion record 138 for the storage access request 137. If the source location as identified by the memory address 124 is in the memory space 121, the memory sub-system 101 specifies the memory address 124 in the completion record 138 for the storage access request 137 as the starting memory address caching the data being written to the storage space 131. The host system 102 can continue using the memory block 211 having the starting memory address 124 identified in the completion record 138 provided for the storage access request 137 (e.g., until the memory block 211 is freed via memory return 244 or access completion 245). Optionally, the memory sub-system 101 can update the metadata 130 to indicate that the data of at least the logical block address 134 is now in the allocated memory block 211 such that, if the content in the allocated memory block 211 is modified, freeing the memory block 211 can cause the writing of the content back according to the logical block address 134.

Optionally, the memory sub-system 101 can support the use of further values for the opcode 240.

For example, an opcode 240 for write and memory return can be used to cause the memory sub-system 101 to free the memory block used in the execution of the storage access request 137 and/or any memory block(s) previously allocated to read from any of the logical block addresses (e.g., 134) currently being read during the execution of the storage access request 137.

For example, an opcode 240 for write and memory request can be used to cause the memory sub-system 101 to allocate a memory block to store the data being written to the storage space 131 according to the logical block address 134 (or a portion of the data being written that is not provided by the memory address 124 in the memory space 121, and/or not provided by the host system 102 in a read-modify-write operation).

For example, an opcode 240 for read and memory return can be used to cause the memory sub-system 101 to free any memory block(s) previously allocated to read from any of the logical block addresses (e.g., 134) currently being read during the execution of the storage access request 137.

In at least some embodiments, the memory sub-system 101 has different types of memory (e.g., SRAM, DRAM) that can be allocated from the memory space 121 in response to requests (e.g., 203, 221, 137) from a host system 102; and a host system 102 can optionally specify at least one attribute of a memory block 211 to be allocated from the memory space 121 such that the memory block 211 is allocated from a memory region, among memory regions of different memory types, that can best meet the demand of an application running in the host system 102.

For example, some applications running in the host system 102 can benefit more from a higher quality of service (QoS) in accessing the memory of the memory sub-system 101. Such applications may request memory blocks (e.g., SRAM) of lower latency and/or better consistency than DRAM. When available, the memory sub-system 101 can allocate a memory block from the higher performance memory in response to a request for a higher quality of service identified by the host system 102.

In some implementations, the host system 102 can specify, in a request (e.g., 203, 221, 137), a hint/suggestion for a desirable attribute of the memory block 211 to be allocated from the memory space 121. When the request is executed in the memory sub-system 101, the memory sub-system 101 can check for free memory resources that has the desirable attribute identified in the request (e.g., 203, 221, 137). If such free memory resources are available, the memory sub-system 101 can allocate a memory block 211 that has the attribute identified in the request (e.g., 203, 221, 137). Otherwise, the memory sub-system 101 can allocate a memory block 211 that has an alternative attribute to best match the desirable attribute suggested/hinted by the host system 102.

In some implementations, the storage access request 221 of FIG. 18 and/or the storage access request 137 of FIG. 19 are configured to be substantially in compliance with a standard of NVMe. Further, a reserved field or a vendor-specific field of a command according to the standard of NVMe is extended or repurposed to provide the hint(s) for the allocation of a memory block 211 during the execution of the storage access request 221 of FIG. 18 and/or the storage access request 137 of FIG. 19.

For example, the memory allocation(s) hint provided by the host system 102 in the request (e.g., 203, 221, 137) can identify one or more memory attributes that are preferred for the allocated memory block 211.

For example, the memory attributes can include an indication of the performance level (e.g., latency, bandwidth) of the memory block (e.g., 211) being requested. When a higher performance level is indicated, the memory sub-system 101 can allocate the memory block 211 from its pool of SRAM, when a sufficient amount of free SRAM is available in the memory sub-system; otherwise, the memory sub-system 101 can allocate the memory block 211 from its pool of DRAM, which is configured to be larger than its pool of SRAM.

For example, the memory attributes can include an indication of the data persistence requirement for the memory block (e.g., 211) being requested.

In some implementations, the memory sub-system 101 can have a portion of the memory space 121 configured as non-volatile. Such a portion of the memory space 121 can be implemented using a non-volatile random access memory (e.g., 3D cross-point memory), or a combination of volatile random access memory (e.g., SRAM or DRAM), a backup power source and a reserved portion of non-volatile memory (e.g., in the storage space 131 and/or in the memory space 121). When the portion of the memory space 121 is implemented using volatile memory, the backup power source is sufficient to allow the memory sub-system 101 to write the data in the portion of the memory space 121 to the reserved portion of the non-volatile memory (e.g., in the storage space 131) in the event of unexpected power outage, such that the data stored in the portion of the memory space 121 can be preserved in the memory sub-system 101 even when there is an unexpected power outage event.

In some instances, data stored into a memory block 211 allocated from the memory space 121 can be recreated from other data in the event of data loss resulting from unexpected power outage; and thus, the host system 102 can specify, in the request (e.g., 203, 221, 137) that causes the allocation of a memory block 211, a hint for the allocation of the memory block 211 as ephemeral. In response, the memory sub-system 101 can avoid allocating the memory block 211 from the portion of the memory space 121 that is configured as non-volatile (e.g., to reserve the resources for other requests that can request for memory blocks that are configured as non-volatile).

In some instances, the data stored into a memory block 211 allocated from the memory space 121 can be mission critical; and the host system 102 can specify, in the request (e.g., 203, 221, 137) that causes the allocation of a memory block 211, a hint (or a requirement) for the allocated memory block 211 being configured as non-volatile. In response, the memory sub-system 101 can allocate the memory block 211 from the portion of the memory space 121 that is configured as non-volatile (e.g., implemented using non-volatile memory cells or supported with a backup power source).

Optionally, the memory attributes specified in the request (e.g., 203, 221, 137) that causes the allocation of a memory block 211 can identify a policy for the disposal of data in the memory block 211 upon de-allocation of the memory block 211. For example, the host system 102 can specify an option to configure the memory block 211 as a cache for the data at a logical block address 134 such that when the memory block 211 is de-allocated, the memory sub-system 101 automatically writes updated data of the logical block address 134 from the memory block 211 to the storage space 131. Alternatively, the host system 102 can specify an option to configure the memory block 211 as a buffer for the data at a logical block address 134 such that when the memory block 211 is de-allocated, the memory sub-system 101 can discard updated data in the memory block 211 without writing the data from the memory block 211 into the storage space 131. When the host system 102 decides to preserve the data in the memory block 211 allocated as a buffer, the host system 102 can send a write command (e.g., 177) to explicitly instruct the memory sub-system 101 to write the data from the memory block 211 to the storage space 131 before freeing the memory block 211.

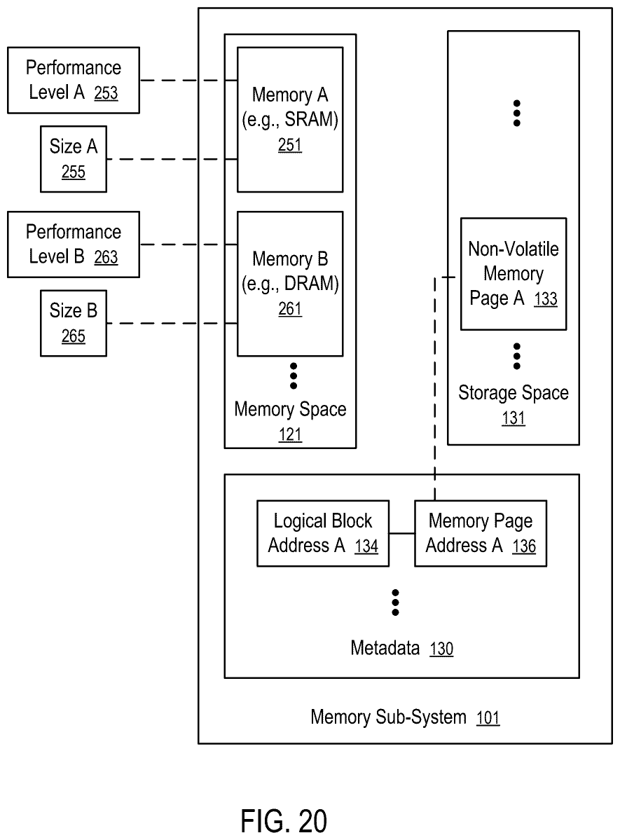

FIG. 20 shows a memory sub-system having a memory space with different types of memory that can be allocated to a host system to access a storage space of the memory sub-system according to one embodiment. For example, the memory sub-system 101 of FIG. 1 and FIG. 2 can include different types of memory in a memory space 121 as in FIG. 20.

In FIG. 20, the memory space 121 of the memory sub-system 101 can have a region of memory 251 (e.g., implemented using SRAM) that has a performance level 253 that is higher than the performance level 263 of another region of memory 261 (e.g., implemented using DRAM). When a memory block 211 is to be allocated for access by a host system 102 (e.g., via a memory allocation request 203 of FIG. 16, a storage access request 221 of FIG. 18, or a storage access request 137 of FIG. 19), the memory block 211 can be allocated from the higher performance memory 251 (e.g., SRAM) or the lower performance memory 261 (e.g., DRAM). The host system 102 can provide a hint to assist the memory sub-system 101 in deciding whether to allocate the memory block 211 from the higher performance memory 251, or from the lower performance memory 261.

In a typical configuration, the size 255 of the higher performance memory 251 configured in the memory sub-system 101 is smaller than the size 265 of the lower performance memory 261. Thus, the hint provided by the host system 102 can guide the memory sub-system 101 in allocating memory resources in a way that improves the overall performance of the computing system 100.

In some implementations, the memory space 121 can further include other types of memory, such as a region of memory configured as non-volatile (e.g., having non-volatile random access memory cells, or configured with a backup power source to write data from the memory space 121 to the storage space 131).

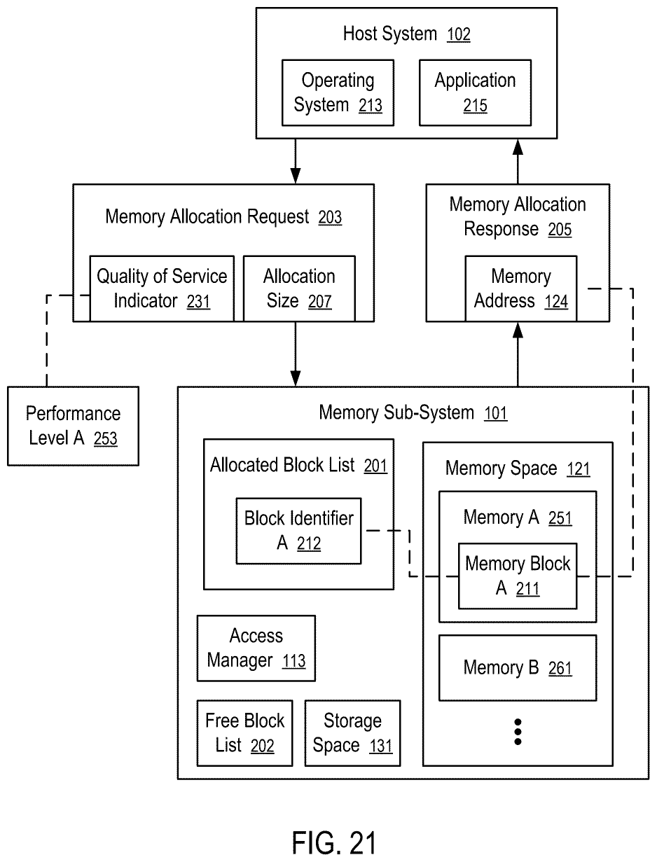

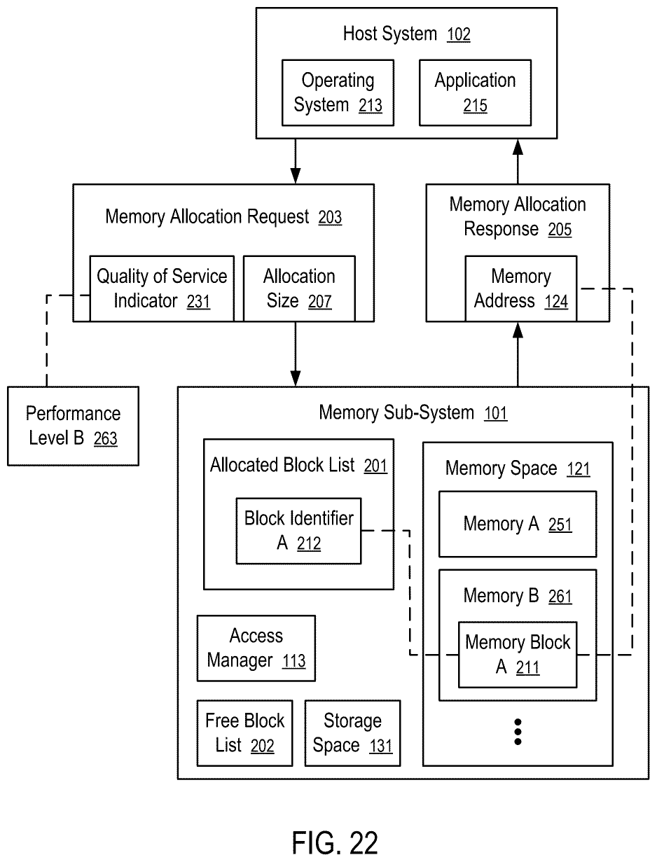

FIG. 21 to FIG. 22 show examples of memory allocation requests having quality of service requests according to one embodiment.

For example, the memory allocation request 203 of FIG. 16 can be augmented to include a field for a quality of service indicator 231 to provide hints that can be used by the memory sub-system 101 (e.g., as configured in FIG. 20) to allocate a memory block 211 in a way as illustrated in FIG. 21 and FIG. 22.

In FIG. 21, the quality of service indicator 231 specified by the host system 102 for the memory allocation request 203 corresponds to a performance level 253 of the higher performance memory 251 in the memory space 121 of the memory sub-system 101.

When the free block list 202 indicates that the region of the higher performance memory 251 has sufficient free memory to satisfy the allocation size 207, the memory sub-system 101 allocates a memory block 211 from the higher performance memory 251, in view of the quality of service indicator 231 provided in the memory allocation request 203.

Since the size 255 of the higher performance memory 251 (e.g., SRAM) configured in the memory sub-system is relatively small, it can occur that when the memory allocation request 203 is executed in the memory sub-system 101, the free block list 202 indicates that the region of the higher performance memory 251 has insufficient free memory to satisfy the allocation size 207. In such a situation, the memory sub-system 101 can allocate a memory block from the lower performance memory 261 (e.g., DRAM), even though the quality of service indicator 231 provided in the memory allocation request 203 hints the performance level 253 of the higher performance memory 251.

In FIG. 22, the quality of service indicator 231 specified by the host system 102 for the memory allocation request 203 corresponds to a performance level 263 of the lower performance memory 261 in the memory space 121 of the memory sub-system 101.

When the free block list 202 indicates that the region of the lower performance memory 261 has sufficient free memory to satisfy the allocation size 207, the memory sub-system 101 allocates a memory block 211 from the lower performance memory 261, in view of the quality of service indicator 231 provided in the memory allocation request 203.

In some instances, it can occur that when the memory allocation request 203 is executed in the memory sub-system 101, the free block list 202 indicates that the region of the lower performance memory 261 has insufficient free memory to satisfy the allocation size 207, but the higher performance memory 251 has sufficient free memory to satisfy the allocation size 207. In such a situation, the memory sub-system 101 can refrain from allocating a memory block 211 from the higher performance memory 251 (e.g., SRAM) (e.g., to reserve the free portion of the high performance memory 251 for applications that have higher demand for performance). Optionally, in view of the small size 255 of the higher performance memory 251 and the quality of service indicator 231 provided in the memory allocation request 203 hinting the allocation at the performance level 263 of the lower performance memory 261, the memory sub-system 101 can decide to postpone the execution of the memory allocation request 203 (e.g., until there are sufficient free memory resources in the region of lower performance memory 261).

FIG. 21 and FIG. 22 illustrate examples of a memory allocation request 203 having a field configured to provide a quality of service indicator 231 related to a performance level (e.g., 253 or 263) of a memory block 211 being allocated. The memory allocation request 203 can be optionally configured to further include one or more fields to provide other memory allocation hints, such as whether the memory block 211 being allocated is to be from a non-volatile region or a volatile region of the memory space 121, whether the memory block 211 is allocated to function as a cache (e.g., with automatic committing to the storage space 131 upon freeing the memory block 211) or a buffer (e.g., allowing data to be discarded upon freeing the memory block 211).

For example, when the memory block 211 is allocated as a cache for a logical block address (e.g., 134), the memory allocation request 203 can further specify the logical block address (e.g., 134). In some implementations, the memory block 211 is allocated as a cache for a portion of the logical storage block represented by a logical block address (e.g., 134), the memory allocation request 203 can specify the logical block address (e.g., 134), and the location and size of the logical storage block being cached using the memory block 211; and execution of the memory allocation request 203 can include the retrieval of the data from the logical block address (e.g., 134) into the memory block 211.

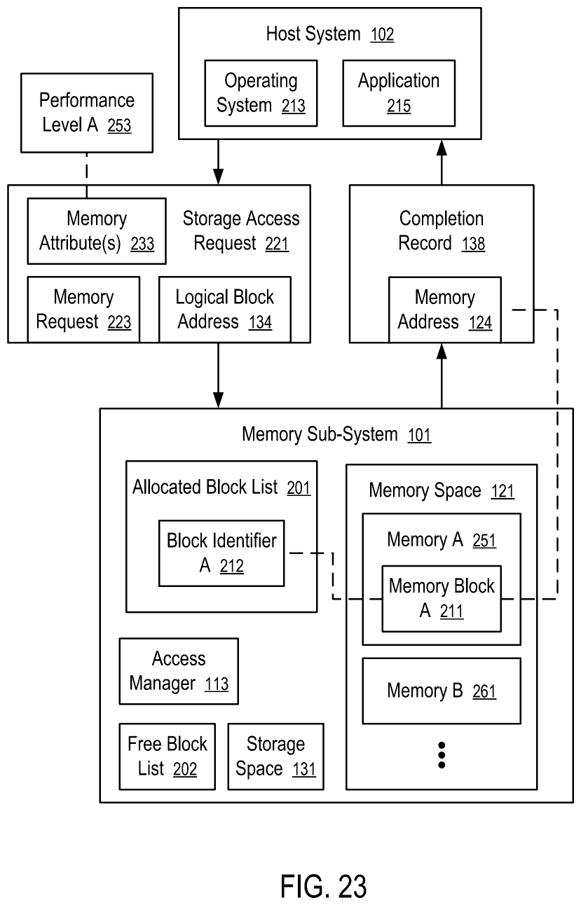

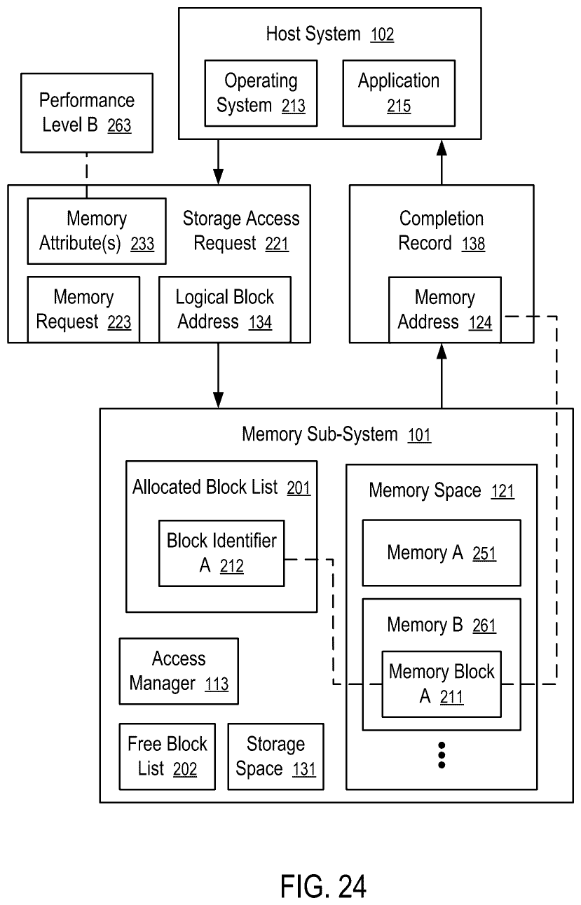

FIG. 23 to FIG. 24 show examples of storage access requests having built-in memory requests with memory attributes for requested memory blocks according to one embodiment.

For example, the storage access request 221 or 137 with a built-in memory request 223 of FIG. 18 can be augmented to include one or more fields for specifying memory attributes 233 as hints or requirements for the memory sub-system 101 (e.g., as configured in FIG. 20) to allocate a memory block 211 in a way as illustrated in FIG. 23 and FIG. 24.

In some implementations, the memory attributes 233 can identify one of a plurality of predefined performance levels (e.g., 253, 263) of memory performance that are pre-associated with the different memory types (e.g., SRAM, DRAM). When memory attributes 233 identify a type of memory that is not configured in the memory sub-system 101, the memory sub-system 101 can consider the amount of free memory of such a type of memory being zero.

Optionally, the memory attributes 233 can specify a target latency and/or memory access bandwidth for the memory block 211 to be allocated during the execution of the storage access request 221; and the memory sub-system 101 can be configured to perform a best effort matching between available free resources as identified by the free block list 202 and the target identified by the memory attribute 233 in selecting a memory region (e.g., memory 251, memory 261, etc.) to allocate the memory block 211.

In FIG. 23, the memory attributes 233 specified by the host system 102 in the storage access request 221 hint a performance level 253 of the higher performance memory 251 in the memory space 121 of the memory sub-system 101. When the free block list 202 indicates that the region of the higher performance memory 251 has sufficient free memory to satisfy the allocation size 207 indicated by the storage access request 221, the memory sub-system 101 allocates a memory block 211 from the higher performance memory 251, in view of the hint provided via the memory attributes 233. However, when the storage access request 221 is executed in the memory sub-system 101, if the free block list 202 indicates that the region of the higher performance memory 251 has insufficient free memory to satisfy the allocation size 207 indicated by the storage access request 221, the memory sub-system 101 can allocate a memory block 211 from the lower performance memory 261 (e.g., DRAM) as a best effort, approximate match in view of resource availability and the hints provided by the memory attributes 233.

In FIG. 24, the memory attributes 233 specified by the host system 102 for the storage access request 221 hint a performance level 263 of the lower performance memory 261 in the memory space 121 of the memory sub-system 101. When the free block list 202 indicates that the region of the lower performance memory 261 has sufficient free memory to satisfy the allocation size 207 to complete the storage access request 221, the memory sub-system 101 allocates a memory block 211 from the lower performance memory 261, in view of the memory attributes 233 identified in the storage access request 221. However, if when the storage the storage access request 221 is executed in the memory sub-system 101, the free block list 202 indicates that the region of the lower performance memory 261 has insufficient free memory to satisfy the allocation size 207 indicated by the storage access request 221 but the region of the higher performance memory 251 has sufficient free memory to satisfy the allocation size 207 for the completion of the storage access request 221, the memory sub-system 101 can optionally allocate a memory block 211 from the high performance memory 251 (e.g., SRAM) as a best effort, approximate match in view of resource availability and the hints provided by the memory attributes 233.

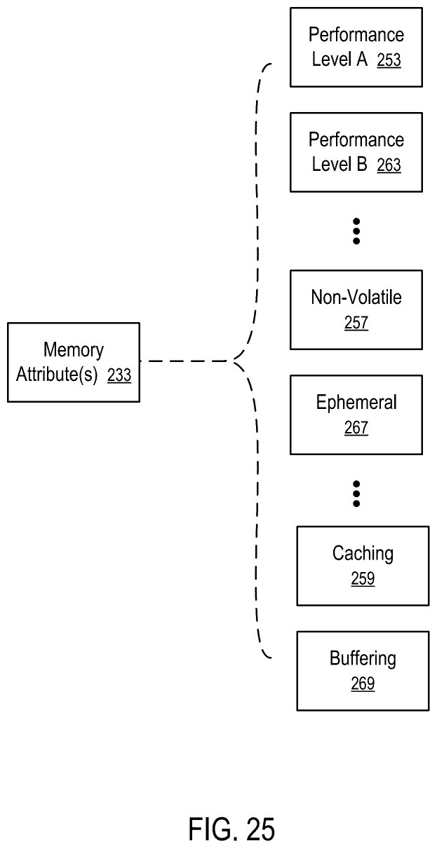

FIG. 23 and FIG. 24 illustrate examples of a storage access request 221 having one or more fields to provide memory allocation hints in terms of memory attributes 233 of a memory block 211 in the area of performance level (e.g., performance tier, memory type, memory access latency, memory access bandwidth) to be allocated during the execution of the storage access request 221. The fields can be further configured to include other hints (e.g., non-volatile, volatile, persistent, ephemeral, caching, buffering) for the allocation and operation of the memory block 211 being allocated during the execution of the storage access request 221, as further illustrated in FIG. 25. Optionally, the storage access request 221 can specify a portion of the memory attributes 233 as hints/suggestions, and another portion of the memory attributes 233 as requirements for the allocation of the memory block 211.

FIG. 25 shows examples of memory attributes usable in requests from a host system to cause a memory sub-system to allocate memory blocks according to one embodiment. For example, the memory attributes illustrated in FIG. 25 can be used as hints, or requirements, for the allocation of the memory block 211 during execution of the storage access request 221 of FIG. 24 and/or during execution of the memory allocation request 203 of FIG. 22.

For example, the host system 102 can specify a performance level 253 and/or a performance level 263 in a request (e.g., 203, 221, 137) for the allocation of a memory block 211 when the memory sub-system 101 executes the request (e.g., 203, 221, 137).

For example, the performance level 253 or 263 can be specified as a memory type (e.g., SRAM, DRAM), or a memory performance tier (e.g., tier 1, tier 2). Alternatively, or in combination, the performance level 253 or 263 can be specified as a target latency and/or a target bandwidth in accessing the allocated memory block 211. When different performance levels 253 and 263 are specified as the memory attributes 233 identified in a request (e.g., 203, 22, 137), the performance levels 253 and 263 as specified in the request (e.g., 203, 221, 137) can have different implied or explicitly specified priorities.

For example, both performance levels 253 and 263 can be specified as the memory attributes 233 in a same request (e.g., 203, 221, 137) but with different orders in a list. A performance level (e.g., 253 or 263) specified in the list before another performance level (e.g., 263 or 253) is given a higher priority in consideration by the memory sub-system 101 in the memory block 211.

For example, the request (e.g., 203, 221, 137) can specify a memory attribute 233 of non-volatile 257 to suggest, or require, the allocation of the memory block for a memory of the memory sub-system 101 that is configured as non-volatile (e.g., implemented using non-volatile memory cells, or a combination of volatile memory cells and a backup power source) such that no data loss would occur during an unexpected power outage event.

For example, the request (e.g., 203, 221, 137) can specify a memory attribute 233 of ephemeral 267 to allow the memory sub-system 101 to allocate the memory block 211 for a memory of the memory sub-system 101 that is configured as volatile (e.g., data loss can occur during an unexpected power outage event).

For example, the request (e.g., 203, 221, 137) can specify a memory attribute 233 of caching 259 to cause the memory sub-system 101 to automatically store updated data in the allocated memory block 211 to the storage space 131 upon freeing of the memory block 211 and/or in response to an unexpected power outage event.

For example, the request (e.g., 203, 221, 137) can specify a memory attribute 233 of buffering 269 to cause the memory sub-system 101 to allow updated data in the allocated memory block 211 to be discarded (e.g., without being stored into the storage space 131 upon freeing of the memory block 211 and/or in response to an unexpected power outage event).

Optionally, the host system 102 can further specify, for a memory attribute specified in a request (e.g., 203, 221, 137), whether the memory attribute is a hint/suggestion, or a requirement, for the allocation of the memory block 211.

When a memory attribute is specified as a requirement for the allocation of the memory block 211 and the memory sub-system 101 does not have sufficient resources to meet the requirement at the time of the execution of the request (e.g., 203, 221, 137), the memory sub-system 101 can abort and/or postpone the execution of the request (e.g., 203, 221, 137). Optionally, the sub-system 101 can report the execution of the request (e.g., 203, 221, 137) having a status of resulting in an error, and identify (e.g., in a memory allocation response 205 or a completion record 138) the error encountered during the execution of the request (e.g., 203, 221, 137). Optionally, the memory sub-system 101 can further identify the attributes of memory resources that are available for allocation from the memory space 121.

When a memory attribute is specified as a hint for the allocation of the memory block 211 and the memory sub-system 101 has sufficient resources to meet the requirement of the memory attribute at the time of the execution of the request (e.g., 203, 221, 137), the memory sub-system 101 can allocate the memory block 211 with the memory attribute (e.g., as if the memory attribute were specified as a requirement). However, when the memory sub-system 101 has insufficient resources to meet the requirement of the memory attribute that is specified as a hint ion the request (e.g., 203, 221, 137), the memory sub-system 101 can ignore the memory attribute in the allocation of the memory block 211 (e.g., as if the memory attribute were not specified in the request (e.g., 203, 221, 137)).

For example, when a memory attribute 233 of ephemeral 267 is specified as a requirement in a request (e.g., 203, 221, 137) and the memory sub-system 101 has insufficient free memory in a region of memory configured as volatile in the memory space 121, the memory sub-system 101 does not allocate the memory block 211 from a region of non-volatile memory in the memory space 121 even though the region of non-volatile memory has sufficient free memory for allocation. Thus, the host system 102 can cause the memory sub-system 101 to reserve non-volatile memory for a mission critical application/data.

Optionally, after the successful allocation of the memory block 211 during the execution of the request (e.g., 203, 221, 137) from the host system 102, the memory sub-system 101 can identify a list of memory attributes of the allocated memory block 211. For example, the list of actual memory attributes of the allocated memory block 211 can be identified with the memory address 124 in a response (e.g., memory allocation response 205, or a completion record 138) for the request (e.g., 203, 221, 137).

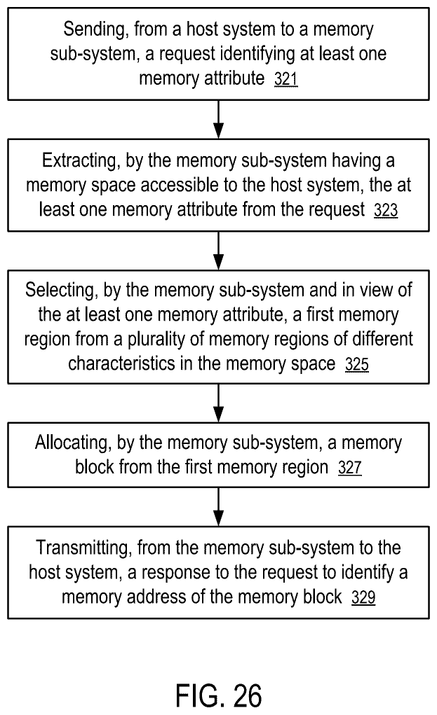

FIG. 26 shows a method to allocate a block of memory from a memory space in a memory sub-system configured with a storage space accessible via a storage access protocol according to one embodiment. The method of FIG. 26 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 26 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 26 can be implemented (e.g., via firmware and application specific circuits) as part of an access manager 113 in the memory sub-system 101 and/or the host system 102.

For example, the memory sub-system 101 can have: memory cells of a first type (e.g., SRAM) to provide a first portion of a memory space 121; memory cells of a second type (e.g., DRAM) to provide a second portion of the memory space 121; and memory cells of a third type (e.g., flash memory) to provide a storage space 131. A controller 115 of the memory sub-system 101 can be configured (e.g., via firmware and/or application specific circuits) to: receive a request (e.g., 203, 221, 137) identifying at least one memory attribute 233 specified by a host system 102 for allocation of a memory block 211 during execution of the request (e.g., 203, 221, 137) in the memory sub-system 101. For example, the request (e.g., 203, 221, 137) can be received from the host system 102 via a submission queue 141 configured according to a storage access protocol (e.g., in compliance with a standard for non-volatile memory express (NVMe)). Optionally, the request (e.g., 221, 137) can be a read command (e.g., 171) with an opcode 240 in compliance with the standard for non-volatile memory express (NMVe) for reading 241 data from the storage space 131.

For example, the memory sub-system 101 can allocate, in view of the at least one memory attribute 233 (e.g., as a hint/suggestion, or as a requirement), the memory block 211 from the memory space 121. The memory sub-system 101 can provide the host system 102 with a response (e.g., memory allocation response 205, completion record 138) to the request (e.g., 203, 221, 137) to identify a memory address 124 of the allocated memory block 211.

For example, the at least one memory attribute 233 can identify a memory performance level (e.g., 253, 263) for the allocation of the memory block 211.

Optionally, the memory sub-system 101 can have a backup power source (e.g., battery, capacitor) sufficient to power the memory sub-system 101 to write data from a third portion of the memory space 121 (e.g., a non-volatile portion of the memory space 121) to the storage space 131 during an unexpected power outage event to prevent data loss. The controller 115 is configured to determine whether to allocate the memory block 211 from the third portion based on the at least one memory attribute 233.

At block 321, the method of FIG. 26 includes sending, from a host system 102 to a memory sub-system 101, a request (e.g., 203, 221, 137) identifying at least one memory attribute 233.

For example, the request (e.g., 203, 221, 137) is sent from the host system 102 to the memory sub-system 101 via a submission queue 141 that is usable for sending, from the host system 102 to the memory sub-system 101, a storage access command (e.g., a read command 171, a write command 177) to access a logical block address 134 having data 151 stored in a storage space 131 of the memory sub-system 101. For example, the storage access command (e.g., a read command 171, a write command 177) can be configured in accordance with a standard for non-volatile memory express (NVMe) to access the storage space 131 of the memory sub-system 101.

For example, the host system 102 can configure the request (e.g., 203, 221, 137) to allocate a memory block 211 from a memory space 121 of the memory sub-system 101. The memory space 121 can include a plurality of memory regions of different characteristics (e.g., in performance level, data protection capability during an unexpected power outage event). The host system 102 can embed, into the request (e.g., 203, 221, 137), data identifying at least one memory attribute 233 usable to identify one of the plurality of memory regions for the allocation of the memory block 211.

At block 323, the method includes extracting, by the memory sub-system 101 having a memory space 121 accessible to the host system 102, the at least one memory attribute 233 from the request (e.g., 203, 221, 137).

At block 325, the method includes selecting, by the memory sub-system 101 and in view of the at least one memory attribute 233, a first memory region from a plurality of memory regions of different characteristics in the memory space 121.

For example, the plurality of memory regions of different characteristics includes the first memory region implemented using first memory cells of a first type (e.g., SRAM or DRAM) and a second memory region implemented using second memory cells of a second type (e.g., DRAM or SRAM).

For example, the plurality of memory regions of different characteristics includes the first memory region implemented using first memory cells of a first type (e.g., volatile or non-volatile) and a second memory region implemented using second memory cells of a second type (e.g., non-volatile or volatile).

For example, the at least one memory attribute 233 can be configured to identify a performance level (e.g., 253, 263) of the memory block 211 to be allocated responsive to the request (e.g., 203, 221, 137). The performance level (e.g., 253, 263) specified in the request (e.g., 203, 221, 137) can be used in combination of information about memory availability (e.g., free block list 202) to identify a memory region from which a memory block 211 is to be allocated for the request (e.g., 203, 221, 137).

At block 327, the method includes allocating, by the memory sub-system 101, a memory block 211 from the first memory region.

At block 329, the method includes transmitting, from the memory sub-system 101 to the host system 102, a response (e.g., memory allocation response 205, completion record 138) to the request (e.g., 203, 221, 137) to identify a memory address 124 of the memory block 211.

For example, the memory address 124 can be provided via a completion queue 143 associated with the submission queue 141 for accessing the storage space 131 of the memory sub-system 101 in compliance with the standard for NMVe.

Optionally, the request (e.g., 203, 221, 137) is further configured to specify whether the memory attribute is a suggestion or a requirement for the allocation of the memory block 211. For example, at least some of the memory attributes 233 are specified as hints/suggestions; and the allocated memory block 211 can have memory attributes 233 incompatible some of hints/suggestions. Optionally, the response (e.g., memory allocation response 205, completion record 138) can include data identifying the memory attributes of the allocated memory block 211.

Optionally, the request (e.g., 203, 221, 137) is further configured to specify a logical block address 134 in a storage space 131 of the memory sub-system 101; and the at least one memory attribute is configured to specify at least whether the memory block 211 to be allocated is configured to cache or buffer the entire data, or a portion of the data at the logical block address 134. When the memory block 211 is allocated for a portion of the data at the logical block address 134, the request (e.g., 203, 221, 137) can further include data to identify the data portion (e.g., 157, 158).

A non-transitory computer storage medium can be used to store instructions programmed to implement the access managers 113 in the host system 102 and the memory sub-system 101. When the instructions are executed by the processing device 118, the controller 115, and the processing device 117, the instructions cause the host system 102 and/or the memory sub-system 101 to perform the methods discussed above.

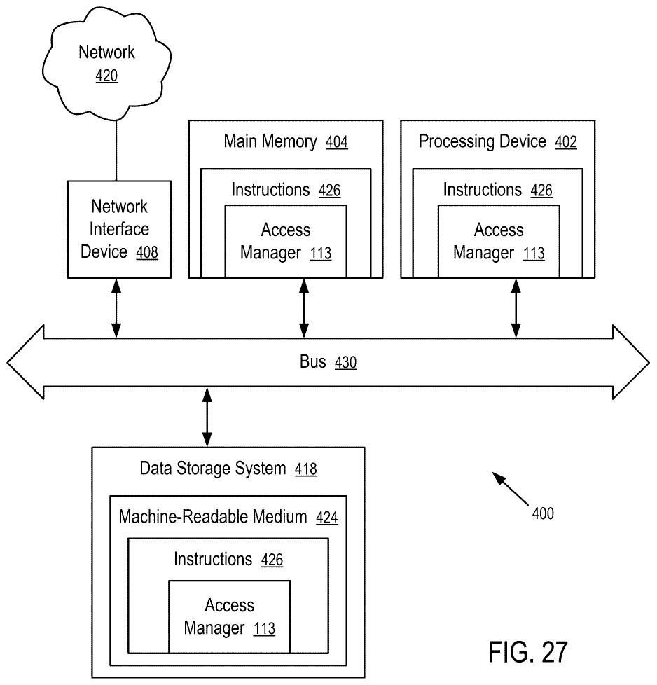

FIG. 27 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of access managers 113 (e.g., to execute instructions to perform operations corresponding to the access managers 113 described with reference to FIG. 1-26). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the access managers 113 described with reference to FIG. 1-26. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method, comprising:
sending, from a host system to a memory sub-system, a request identifying at least one memory attribute;
extracting, by the memory sub-system having a memory space accessible to the host system, the at least one memory attribute from the request;
selecting, by the memory sub-system and in view of the at least one memory attribute, a first memory region from a plurality of memory regions of different characteristics in the memory space; and
allocating, by the memory sub-system, a memory block from the first memory region.

2. The method of claim 1, wherein the request is sent from the host system to the memory sub-system via a submission queue; and the method further comprises:
transmitting, from the memory sub-system to the host system, a response to the request to identify a memory address of the memory block;
sending, from the host system via the submission queue to the memory sub-system, a read command to access a logical block address having data stored in a storage space of the memory sub-system.

3. The method of claim 2, wherein the read command is configured in accordance with a standard for non-volatile memory express (NVMe).

4. The method of claim 3, wherein the memory address is provided via a completion queue associated with the submission queue.

5. The method of claim 4, wherein the plurality of memory regions of different characteristics includes the first memory region implemented using first memory cells of a first type and a second memory region implemented using second memory cells of a second type.

6. The method of claim 5, wherein the first type and the second type are different ones of static random access memory (SRAM) and dynamic random access memory (DRAM).

7. The method of claim 5, wherein the first type and the second type are different ones of volatile and non-volatile.

8. The method of claim 5, wherein the request is further configured to specify whether the memory attribute is a suggestion or a requirement for allocation of the memory block.

9. The method of claim 1, wherein the request is further configured to specify a logical block address in a storage space of the memory sub-system; and the at least one memory attribute is configured to specify at least whether the memory block is configured to cache or buffer data at the logical block address.

10. The method of claim 9, wherein the at least one memory attribute is configured to identify a performance level of the memory block to be allocated responsive to the request.

11. A memory sub-system, comprising:
memory cells of a first type to provide a first portion of a memory space;
memory cells of a second type to provide a second portion of the memory space;
memory cells of a third type to provide a storage space; and
a controller configured to:
receive a request identifying at least one memory attribute specified by a host system; and
allocate, in view of the at least one memory attribute, a memory block from the memory space.

12. The memory sub-system of claim 11, wherein the controller is further configured to provide the host system with a response to the request to identify a memory address of the memory block;
wherein the first type is static random access memory (SRAM), the second type is dynamic random access memory (DRAM), and the third type is flash memory.

13. The memory sub-system of claim 12, wherein the at least one memory attribute is configured to identify a memory performance level for allocation of the memory block.

14. The memory sub-system of claim 13, further comprising:
a backup power source sufficient to power the memory sub-system to write data from a third portion of the memory space to the storage space during an unexpected power outage event; and
wherein the controller is configured to determine whether to allocate the memory block from the third portion based on the at least one memory attribute.

15. The memory sub-system of claim 14, wherein the request is received from the host system via a submission queue configured according to a storage access protocol.

16. The memory sub-system of claim 15, wherein the storage access protocol is in compliance with a standard for non-volatile memory express (NVMe).

17. The memory sub-system of claim 16, wherein the request includes an opcode in compliance with the standard for non-volatile memory express (NMVe) for reading data from the storage space.

18. A non-transitory computer storage medium storing instructions which, when executed in a computing system, cause the computing system to perform a method, comprising:
configuring a request to allocate a memory block from a memory space of a memory sub-system, the memory space including a plurality of memory regions of different characteristics in the memory space;
embedding, into the request, data identifying at least one memory attribute usable to identify one of the plurality of memory regions; and
providing the request to the memory sub-system.

19. The non-transitory computer storage medium of claim 18, wherein the method further comprises:
receiving, from the memory sub-system, a response to the request to identify a memory address of the memory block allocated from one of the plurality of memory regions,
wherein different characteristics including different performance levels, and different data loss prevention capabilities during an unexpected power outage event.

20. The non-transitory computer storage medium of claim 19, wherein the request further identifies a logical block address in a storage space of the memory sub-system and whether the memory block is allocated to cache or buffer a portion of data at the logical block address.
